(19) United States
(12) Patent Application Publication
(10) Pub. No.: US 2010/0062701 A1
(43) Pub. Date: Mar. 11, 2010

(54) COIN DEPOSITING AND DISPENSING MACHINE

(75) Inventor: Takushi Ohno, Himeji-shi (JP)

Correspondence Address: DARBY & DARBY P.C., P.O. BOX 770, Church Street Station, New York, NY, 10008-0770, US

(73) Assignee: Glory Ltd., Himeji-shi (JP)

(21) Appl. No.: 12/527,006

(22) PCT Filed: Feb. 14, 2007
(86) PCT No.: PCT/JP2007/052627

§ 371 Date: Aug. 13, 2009

(51) Int. Cl. G07D 1/00; G07D 9/00

(52) U.S. Cl. 453/57; 453/18

(57) ABSTRACT

A coin depositing and dispensing machine having an accommodating and dispensing portion enabling coins to enter/exit a transporting unit, and the transporting unit can be used for both a depositing and a dispensing system. This enables the coin dispensing port, collection coin dispensing port and replenishment coin input slots to be flexibly arranged in a front face, rear face, and upper face or rear face, of a machine body respectively. Coins to be dispensed and coins to be collected can be dispensed from the collection coin dispensing port in the rear face of the machine body. Additionally, coins for replenishment are put into the replenishment coin input slot, and the accommodating and dispensing portion can be directly replenished with coins through a replenishment chute portion.

### CROSS REFERENCE TO PRIOR RELATED APPLICATIONS

This is a U.S. national phase application under 35 U.S.C. §371 of International Patent Application No. PCT/JP2007/052627 filed Feb. 14, 2007. The International Application was published on Aug. 21, 2008 as International Publication No. WO/2008/099477 under PCT Article 21 (2), and the contents of these applications are incorporated herein in their entireties.

### TECHNICAL FIELD

The present invention relates to a coin depositing and dispensing machine enabling depositing and dispensing of coins.

### BACKGROUND OF THE INVENTION

Conventionally, a coin depositing and dispensing machine, such as an automatic change dispenser, which enables depositing of coins paid by customers and dispensing change, has been used for accurately and promptly accepting cash from/delivering cash to customers in, for example, a shop.

In such a coin depositing and dispensing machine, a coin receiving port and coin dispensing port are provided in one face of a machine body in the case where a cashier operates depositing and dispensing of coins or a customer operates depositing and dispensing of coins by himself/herself. Additionally, in the case of counter management between a cashier and customer, a coin receiving port, into which coins received from the customer are put, is formed on the cashier side, and a coin dispensing port, from which coins as change are dispensed, is formed on the customer side (see, for example, Japanese Patent Publication No. 3803202 (p. 3, FIGS. 1-5)).

Additionally, there exists a coin depositing and dispensing machine including a coin receiving port and coin dispensing port at a front face side of the machine body, wherein coins for replenishment can be put into the machine from a rear face side of a machine body. In the coin depositing and dispensing machine, coins put in from the rear face side of the machine body are received into a dispensing and transporting system, sent from the dispensing and transporting system to a depositing and transporting system, recognized one by one by the depositing and transporting system and sorted for each denomination, and an accommodating and dispensing portion of each denomination is replenished with coins (see, for example, Japanese Laid-open Patent Publication No. 2003-44895 (p. 19, FIG. 1)).

However, in a coin depositing and dispensing machine enabling counter management, a coin receiving port is provided at a cashier side and a coin dispensing port is provided at a customer side, and thus the structure of a machine becomes complicated and causes a cost increase.

Additionally, in the case where excess coins (over-depositing coins) remain in a machine body, coins cannot be collected into a cassette installed in the machine body one time and it takes a lot of time to collect the coins, and thus a great burden falls on the operator. Further, excess coins, which are deposited coins not recycled as coins to be dispensed, are left in the machine, and thus the efficiency of fund management is lowered.

Generally, in the case where all of the coins prepared as change are paid, a transaction must be stopped and coins equivalent to a shortfall must be put in again for replenishment. Thus, it takes time to restart the transaction. Accordingly, in many such coin depositing and dispensing machines, the efficiency of machine management and operability are lowered.

The present invention has been made in view of the above problems, and aims at providing a coin depositing and dispensing machine having a simple constitution enabling a coin dispensing port, collection coin dispensing port or replenishment coin input slots to be flexibly arranged and having excellent efficiencies of machine management and fund management.

### SUMMARY OF THE INVENTION

A coin depositing and dispensing machine according to the present invention includes: a coin receiving port which is disposed in the front of a machine body and receives coins from the outside of the machine body; a coin dispensing port which is disposed in the front of the machine body and from which coins are dispensed to the outside of the machine body; a dispensing tray for receiving coins dispensed from the coin dispensing port to the outside of the machine body; a collection coin dispensing port which is disposed at the rear of the machine body and from which coins are dispensed to the outside of the machine body; a collection coin dispensing port door for closing/opening the collection coin dispensing port; a feeding unit for receiving coins put in the coin receiving port and feeding coins one by one; a transporting unit for transporting coins fed by the feeding unit and transporting coins to be dispensed to the coin dispensing port and collection coin dispensing port; a recognition unit for recognizing at least a denomination of a coin transported by the transporting unit; an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit; and a coin cassette which is disposed removably from the machine body and capable of collecting coins in the machine body.

A coin depositing and dispensing machine according to the present invention includes: a coin receiving port which is disposed in the front of a machine body and receives coins from the outside of the machine body; a coin dispensing port which is disposed in the front of the machine body and from which coins are dispensed to the outside of the machine body; a collection coin dispensing port which is disposed at the rear of the machine body and from which coins are dispensed to the outside of the machine body; a collection coin dispensing port door for closing/opening the collection coin dispensing port; a dispensing tray for receiving coins dispensed from the collection coin dispensing port to the outside of the machine body; a feeding unit for receiving coins put in the coin receiving port and feeding coins one by one; a transporting unit for transporting coins fed by the feeding unit and transporting coins to be dispensed to the coin dispensing port and collection coin dispensing port; a recognition unit for recognizing at least a denomination of a coin transported by the transporting unit; an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit; a coin cassette which is disposed removably from the machine body and capable of collecting coins in the machine body; and a collection dispensing controlling portion for dispensing coins accommodated in the machine body from the collection coin dispensing port.

A coin depositing and dispensing machine according to the present invention includes: a coin receiving port which is disposed in the front of a machine body and receives coins from the outside of the machine body; a coin dispensing port which is disposed in the front of the machine body and from which coins are dispensed to the outside of the machine body; a dispensing tray for accepting coins dispensed from the coin dispensing port to the outside of the machine body; a feeding unit for receiving coins put in the coin receiving port and feeding coins one by one; a transporting unit for transporting coins fed by the feeding unit and transporting coins to be dispensed to the coin dispensing port; a recognition unit for recognizing at least a denomination of a coin transported by the transporting unit; an accommodating and dispensing portion which has a coin inlet/outlet through which coins can enter/exit the transporting unit, receiving coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit; a coin cassette which is disposed removably from the machine body and capable of collecting coins in the machine body; a replenishment coin input slot which is disposed at least at an upper side or rear side of the machine body and into which coins for replenishment are put from the outside of the machine body; a replenishment coin input slot door for opening/closing the replenishment coin input slot; and a replenishment chute portion for guiding coins put in from the replenishment coin input slot to the accommodating and dispensing portion.

A coin depositing and dispensing machine according to the present invention includes: a coin receiving port which is disposed in the front of a machine body and receives coins from the outside of the machine body; a coin dispensing port which is disposed in the front of the machine body and from which coins are dispensed to the outside of the machine body; a collection coin dispensing port which is disposed at the rear of the machine body and from which coins are dispensed to the outside of the machine body; a collection coin dispensing port door for closing/opening the collection coin dispensing port; a feeding unit for receiving coins put in the coin receiving port and feeding coins one by one; a transporting unit for transporting coins fed by the feeding unit and transporting coins to be dispensed to the coin dispensing port and collection coin dispensing port; a recognition unit for recognizing at least a denomination of a coin transported by the transporting unit; an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit; a coin cassette which is disposed removably from the machine body and capable of collecting coins in the machine body; a dispensing tray which can receive coins dispensed from the coin dispensing port and collection coin dispensing port respectively, the dispensing tray being removable from the collection coin dispensing port; a replenishment coin input slot which is disposed at least at an upper side or rear side of the machine body and into which coins for replenishment are put from the outside of the machine body; a replenishment coin input slot door for opening/closing the replenishment coin input slot; a replenishment chute portion for guiding coins put in from the replenishment coin input slot to the accommodating and dispensing portion; and a collection dispensing controlling portion for dispensing coins accommodated in the machine body from the collection coin dispensing port.

With a coin depositing and dispensing machine according to the present invention, in the coin depositing and dispensing machine according to any of the above descriptions of the invention, an escrow unit includes: a chute portion which has a hollow and cylindrical shape having opened upper and lower faces, and a lower part tilted in relation to a vertical direction of the machine body, and can receive coins from the upper face, the coins being transported by the transporting unit; a rotation-driving unit for rotating the chute portion around a vertical axis passing through the center of the upper face of the chute portion; and a rotation position controlling portion which controls switching of, with use of the rotation-driving unit, a rotation position of the chute portion to a storage position for storing coins received inside from the upper face of the chute portion, or to an ejecting position for directly ejecting coins from the lower face without storage.

With a coin depositing and dispensing machine as described above, the escrow unit is disposed above the coin cassette and feeding unit.

With a coin depositing and dispensing machine according to the present invention, in the coin depositing and dispensing machine as described above, the rotation position controlling unit controls switching of a rotation position of the chute portion to a first rotation position which is a storage position for storing coins inside, the coins being received from the upper face of the chute portion, a second rotation position for sending coins, which are received from the upper face of the chute portion, to the coin cassette, or a third rotation position for sending coins, which are received from the upper face of the chute portion, to the feeding unit.

A coin depositing and dispensing machine as described above furthermore includes: a depositing controlling portion by which, when a depositing instruction is received from the outside of the machine body, the chute portion of the escrow unit is rotated to the first rotation position, the feeding unit and transporting unit are driven, coins received in the coin receiving port are fed one by one by the feeding unit and transported by the transporting unit, coins recognized as normal coins by the recognition unit are transported to the escrow unit, and coins not recognized as normal coins are transported to the dispensing tray.

A coin depositing and dispensing machine as described above furthermore includes: an accommodation controlling portion by which, when an accommodating instruction is received from the outside of the machine body, the chute portion of the escrow unit is rotated to the third rotation position, coins stored in the escrow unit are sent to the feeding unit, the feeding unit and transporting unit are driven, the coins fed to the feeding unit are fed one by one by the feeding unit and transported by the transporting unit, a coin recognized as a normal coin by the recognition unit is transported to the coin cassette when the accommodating and dispensing portion for accommodating the corresponding coin is in a full state, or transported to the corresponding accommodating and dispensing portion when the accommodating and dispensing portion is not in the full state, and coins not recognized as normal coins by the recognition unit are transported to the coin cassette.

A coin depositing and dispensing machine as described above furthermore includes: a return controlling portion by which, when a returning instruction is received from the outside of the machine body, the chute portion of the escrow unit is rotated to the third rotation position, coins stored in the escrow unit are sent to the feeding unit, the feeding unit and transporting unit are driven, the coins sent to the feeding unit are fed one by one by the feeding unit and transported by the transporting unit, and all coins stored in the escrow unit are transported to the dispensing tray.

A coin depositing and dispensing machine as described above furthermore includes: a dispensing controlling portion by which, when a dispensing instruction including the denominations and number of coins to be dispensed or dispensing amount is received from the outside of the machine body, the feeding unit, transporting unit and accommodating and dispensing portion are driven, coins accommodated in the accommodating and dispensing portion are dispensed one by one and transported by the transporting unit, coins recognized as normal coins by the recognition unit are transported to the dispensing tray, and coins not recognized as normal coins are transported to the feeding unit.

A coin depositing and dispensing machine as described above furthermore includes: a dispensing reject controlling portion by which, when a dispensing instruction including the denominations and number of coins to be dispensed or dispensing amount is received from the outside of the machine body, the chute portion of the escrow unit is rotated to the second rotation position, the feeding unit, transporting unit and accommodating and dispensing portion are driven, coins accommodated in the accommodating and dispensing portion are dispensed one by one and transported by the transporting unit, coins recognized as normal coins by the recognition unit are transported to the dispensing tray, coins not recognized as normal coins are transported to the feeding unit, and re-fed one by one from the feeding unit and transported by the transporting unit after coins according to the dispensing instruction regarding the denominations and number of coins to be dispensed or dispensing amount are transported to the dispensing tray, coins recognized as normal coins by the recognition unit are transported to the corresponding accommodating and dispensing portion, and coins not recognized as normal coins are transported to the coin cassette.

With a coin depositing and dispensing machine according to the present invention, the coin depositing and dispensing machine furthermore includes a dispensing escrow unit including: a dispensing chute portion which has a hollow and cylindrical shape having opened upper and lower faces, and a lower part tilted in relation to a vertical direction of the machine body, and can receive coins from the upper face, the coins being transported by the transporting unit; a dispensing chute portion rotation-driving unit for rotating the dispensing chute portion around a vertical axis passing through the center of the upper face of the dispensing chute portion; and a dispensing chute portion rotation position controlling portion which controls switching of, with use of the dispensing chute portion rotation-driving unit, a rotation position of the dispensing chute portion to a storage position for storing coins received inside from the upper face of the dispensing chute portion or to an ejecting position for directly ejecting coins from the lower face without storage.

With a coin depositing and dispensing machine according to the present invention, in the coin depositing and dispensing machine, the lower face of the dispensing chute portion of the dispensing escrow unit is disposed at least above the dispensing tray disposed on a front face side of the machine body.

With a coin depositing and dispensing machine according to the present invention, in the coin depositing and dispensing machine, the dispensing chute portion rotation position controlling unit switches a rotation position of the dispensing chute portion to a first dispensing escrow unit position for storing coins inside, which are received from the upper face of the dispensing chute portion, a second dispensing escrow unit position for sending coins, which are received from the upper face of the dispensing chute portion, to the dispensing tray, or a third dispensing escrow unit position for sending coins, which are received from the upper face of the dispensing chute portion, to the coin cassette.

The coin depositing and dispensing machine furthermore includes: a dispensing escrow controlling portion by which, when a dispensing instruction including the denominations and number of coins to be dispensed or dispensing amount is received from the outside of the machine body, the dispensing chute portion of the dispensing escrow unit is rotated to the first dispensing escrow unit position, the feeding unit, transporting unit and accommodating and dispensing portion are driven, coins accommodated in the accommodating and dispensing portion are fed one by one and transported by the transporting unit, coins recognized as normal coins by the recognition unit are transported to the dispensing escrow unit, and coins not recognized as normal coins are transported to the feeding unit.

The coin depositing and dispensing machine of the invention furthermore includes: a dispensing escrow reject controlling portion by which, when a dispensing instruction including the denominations and number of coins to be dispensed or dispensing amount is received from the outside of the machine body, the dispensing chute portion of the dispensing escrow unit is rotated to the first dispensing escrow unit position, the feeding unit, transporting unit and accommodating and dispensing portion are driven, coins accommodated in the accommodating and dispensing portion are fed one by one and transported by the transporting unit, coins recognized as normal coins by the recognition unit are transported to the dispensing escrow unit, coins not recognized as normal coins are transported to the feeding unit, all coins according to the dispensing instruction regarding the denominations and number of coins to be dispensed or dispensing amount are transported to the dispensing escrow unit, and then the dispensing chute portion of the dispensing escrow unit is rotated to the second dispensing escrow unit position, coins to be dispensed in the dispensing escrow unit are sent to the dispensing tray, and the coins not recognized as normal coins are re-fed one by one from the feeding unit and transported by the transporting unit, coins recognized as normal coins by the recognition unit are transported to the corresponding accommodating and dispensing portion, and coins not recognized as normal coins are transported to the coin cassette.

The coin depositing and dispensing machine of the invention furthermore includes: a replenishment controlling portion by which, when a replenishing instruction is received from the outside of the machine body, the chute portion of the escrow unit is rotated to the second rotation position, the feeding unit and transporting unit are driven, coins for replenishment received from the coin receiving port are fed one by one by the feeding unit and transported by the transporting unit, a coin for replenishment recognized as a normal coin by the recognition unit is transported to the coin cassette when the accommodating and dispensing portion for accommodating the corresponding coin is in a full state, or transported to the corresponding accommodating and dispensing portion when the accommodating and dispensing portion is not in the full state, and coins for replenishment not recognized as normal coins by the recognition unit are transported to the dispensing tray.

A coin depositing and dispensing machine according to the present invention furthermore includes: an individual replenishment controlling portion by which, when an individual replenishing instruction including information on the denomination of a coin for replenishment is received from the outside of the machine body, after the corresponding replenishment coin input slot door is opened and coins put in the replenishment coin input slot are received in the corresponding accommodating and dispensing portion, close of the replenishment coin input slot door is detected, and thus the transporting unit and accommodating and dispensing portion are driven, coins are fed one by one from the accommodating and dispensing portion and transported to the feeding unit by the transporting unit, the accommodating and dispensing portion is stopped after all coins in the accommodating and dispensing portion are fed, the feeding unit and transporting unit are driven, coins are fed one by one from the feeding unit and transported by the transporting unit, coins recognized as normal coins by the recognition unit are transported to the coin cassette when the accommodating and dispensing portion for accommodating the corresponding coin in a full state, or transported to the corresponding accommodating and dispensing portion when the accommodating and dispensing portion is not in the full state, and coins not recognized as normal coins by the recognition unit are transported to the coin cassette.

A coin depositing and dispensing machine according to the present invention furthermore includes: an individual replenishment controlling portion by which, when an individual replenishing instruction including information on the denomination of a coin for replenishment is received from the outside of the machine body, the corresponding replenishment coin input slot door is opened, and coins are received into the replenishment coin input slot from the outside of the machine body and sent to the corresponding accommodating and dispensing portion through the replenishment chute portion.

A coin depositing and dispensing machine according to the present invention furthermore includes: a dispensing replenishment controlling portion by which, when a dispensing instruction including the denominations and number of coins to be dispensed or dispensing amount is received from the out side of the machine body, the feeding unit, transporting unit and accommodating and dispensing portion are driven, coins accommodated in the accommodating and dispensing portion are dispensed one by one and transported by the transporting unit, coins recognized as normal coins to be dispensed by the recognition unit are transported to the dispensing tray, coins not recognized as normal coins and coins recognized as normal coins but not the coins to be dispensed are transported to the feeding unit, all coins according to the dispensing instruction regarding the denominations and number of coins to be dispensed or dispensing amount are transported to the dispensing tray, and then coins are fed one by one from the feeding unit and transported by the transporting unit, a coin recognized as a normal coin by the recognition unit is transported to the coin cassette when the accommodating and dispensing portion for accommodating the corresponding coin is in a full state, or transported to the corresponding accommodating and dispensing portion when the accommodating and dispensing portion is not in the full state, and coins not recognized as normal coins by the recognition unit are transported to the coin cassette.

A coin depositing and dispensing machine according to the present invention furthermore includes: a collection controlling portion by which, when a collecting instruction is received from the outside of the machine body, the chute portion of the escrow unit is rotated to the second rotation position, the feeding unit, transporting unit and accommodating and dispensing portion are driven, and coins accommodated in the accommodating and dispensing portion are fed one by one and transported to the coin cassette by the transporting unit.

A coin depositing and dispensing machine according to the present invention furthermore includes an outside collection controlling portion by which, when an outside collecting instruction is received from the outside of the machine body, the feeding unit, transporting unit and accommodating and dispensing portion are driven, and coins accommodated in the accommodating and dispensing portion are fed one by one and transported to the collection coin dispensing port by the transporting unit.

The coin depositing and dispensing machine furthermore includes sorting members for sorting coins transported by the transporting unit to the accommodating and dispensing portion in accordance with a result of recognition by the recognition unit.

In the coin depositing and dispensing machine as described above, the transporting unit has a circular coin passage and an endless transporting body having a plurality of projections for pushing and transporting coins in the coin passage one by one and capable of moving along the coin passage.

With a coin depositing and dispensing machine according to the present invention, in the coin depositing and dispensing machine according to the invention, the feeding unit and accommodating and dispensing portion each includes a rotary disc which is rotated, around a rotary axis attached to the machine body, at a position tilted at a predetermined angle in relation to a horizontal direction, and a hopper for accommodating coins, which are received on a surface side of the rotary disc, with the coins not aligned.

According to a coin depositing and dispensing machine of the present invention, since an accommodating and dispensing portion can make coins enter/exit a transporting unit and the transporting units of a depositing system and a dispensing system can be made common to each other, a simple mechanism enables a coin dispensing port and collection coin dispensing port to be flexibly arranged in a front face and rear face of a machine body respectively: coins to be collected can be collected from the rear face of the machine body by dispensing the coins from the collection coin dispensing port; and efficiencies of machine management and fund management can be raised.

According to a coin depositing and dispensing machine of the present invention, since an accommodating and dispensing portion can make coins enter/exit a transporting unit and the transporting units of a depositing system and a dispensing system can be made common to each other, a simple mechanism enables a coin dispensing port and collection coin dispensing port to be flexibly arranged in a front face and rear face of a machine body respectively: counter management can be performed by dispensing coins to be dispensed from the collection coin dispensing port and receiving the coins by a dispensing tray; coins to be collected can be collected from the rear face of the machine body by dispensing the coins from the collection coin dispensing port; and efficiencies of machine management and fund management can be raised.

According to a coin depositing and dispensing machine of the present invention, since an accommodating and dispensing portion can make coins enter/exit a transporting unit and the transporting units of a depositing system and a dispensing system can be made common to each other, a simple mechanism enables a coin dispensing port and replenishment coin input slots to be flexibly arranged; the accommodating and dispensing portion can be directly replenished with coins from a rear face of a machine body through a replenishment chute portion by putting coins for replenishment into the replenishment coin input slot; and efficiencies of machine management and fund management can be raised.

According to a coin depositing and dispensing machine of the present invention, since an accommodating and dispensing portion can make coins enter/exit a transporting unit and the transporting units of a depositing system and a dispensing system can be made common to each other, a simple mechanism enables a coin dispensing port, collection coin dispensing port and replenishment coin input slots to be flexibly arranged in a front face, rear face, and upper or rear face of a machine body respectively; counter management can be performed by dispensing coins to be dispensed from the collection coin dispensing port and receiving the coins by a dispensing tray; coins to be collected can be collected from the rear face of the machine body by dispensing the coins from the collection coin dispensing port; the accommodating and dispensing portion can be directly replenished with coins from the rear face of the machine body through a replenishment chute portion by putting coins for replenishment into the replenishment coin input slot; and efficiencies of machine management and fund management can be raised.

According to a coin depositing and dispensing machine of the present invention, in addition to the effect of the coin depositing and dispensing machine, coins received inside from an upper face of a chute portion can be stored by rotating the chute portion to a storage position and can be directly ejected from a lower face of the chute portion, without storage, by rotating the chute portion to an ejecting position, and an escrow unit can be downsized and simplified, because the chute portion is used for the escrow unit, the chute portion being in a hollow cylindrical shape having the opened upper and lower faces, having a lower part tilted in relation to a vertical direction of the machine body, and being rotated around a vertical axis passing through the center of the upper face.

According to a coin depositing and dispensing machine of the present invention, in addition to the effect of the coin depositing and dispensing machine according to the above, the escrow unit is disposed above the coin cassette and feeding unit, and coins ejected from the escrow unit can be sent to a coin cassette and feeding unit.

According to a coin depositing and dispensing machine of the present invention, by controlling switching of a rotation position of the chute portion, coins received from the upper face of the chute portion can be stored inside at a first rotation position, coins received from the upper face of the chute portion can be sent to the coin cassette at a second rotation position, and coins received from the upper face of the chute portion can be sent to the feeding unit at a third rotation position.

According to a coin depositing and dispensing machine of the present invention, when a depositing instruction is received from the outside of the machine body, the chute portion of the escrow unit is rotated to the first rotation position, and thus coins are transported and can be stored into the escrow unit, the coins being received in the coin receiving port, fed one by one by the feeding unit, transported by the transporting unit and recognized as normal coins by a recognition unit, and coins not recognized as normal coins can be transported to the dispensing tray.

According to a coin depositing and dispensing machine of the present invention, when an accommodating instruction is received from the outside of the machine body, the chute portion of the escrow unit is rotated to the third rotation position, and thus coins stored in the escrow unit are sent to the feeding unit, fed one by one by the feeding unit and transported by the transporting unit, a coin recognized as a normal coin by the recognition unit is transported to the coin cassette and can be collected when the accommodating and dispensing portion for accommodating the corresponding coin is in a full state, or can be transported and accommodated into the corresponding accommodating and dispensing portion when the accommodating and dispensing portion is not in the full state, and coins not recognized as normal coins by the recognition unit are transported to the coin cassette and can be collected.

According to a coin depositing and dispensing machine of the present invention, when a returning instruction is received from the outside of the machine body, the chute portion of the escrow unit is rotated to the third rotation position, and thus all coins stored in the escrow unit are sent to the feeding unit, fed one by one by the feeding unit, transported by the transporting unit to the dispensing tray and can be returned.

According to a coin depositing and dispensing machine of the present invention, when a dispensing instruction including the denominations and number of coins to be dispensed or dispensing amount is received from the outside of the machine body, coins accommodated in the accommodating and dispensing portions are dispensed one by one and transported by the transporting unit, coins recognized as normal coins by the recognition unit are transported to the dispensing tray, and coins not recognized as normal coins are transported to the feeding unit and can be prevented from being dispensed.

According to a coin depositing and dispensing machine of the present invention in addition to the effect above, when a dispensing instruction including the denominations and number of coins to be dispensed or dispensing amount is received from the outside of the machine body, the chute portion of the escrow unit is rotated to the second rotation position, and thus coins are transported to the dispensing tray and can be dispensed, the coins being dispensed one by one from the accommodating and dispensing portions, transported by the transporting unit and recognized as normal coins by the recognition unit, coins not recognized as normal coins are transported to the feeding unit, and re-fed one by one from the feeding unit and transported by the transporting unit after all coins according to the dispensing instruction regarding the denominations and number of coins to be dispensed or dispensing amount are transported to the dispensing tray, coins recognized as normal coins by the recognition unit are transported and can be accommodated into the corresponding accommodating and dispensing portions, and coins not recognized as normal coins are transported to the coin cassette and can be collected.

According to a coin depositing and dispensing machine of the present invention, coins received inside from an upper face of a dispensing chute portion can be stored by rotating the dispensing chute portion to a storage position, and can be directly ejected from a lower face of the dispensing chute portion by rotating the dispensing chute portion to an ejecting position, and a dispensing escrow unit can be downsized and simplified, because the dispensing chute portion is used for the dispensing escrow unit, the dispensing chute portion being in the shape of a cylindrical hollow having the opened upper and lower faces, having a lower part tilted in relation to a vertical direction of the machine body and rotating around a vertical axis passing through the center of the upper face.

According to a coin depositing and dispensing machine of the present invention, in addition to the effect of the coin depositing and dispensing machine according to the above, since the lower face of the dispensing chute portion of the dispensing escrow unit is disposed at least above the dispensing tray disposed on the front face side of the machine body, coins ejected from the dispensing escrow unit can be sent to the dispensing tray.

According to a coin depositing and dispensing machine of the present invention, in addition to the effect of the coin depositing and dispensing machine according to the above, by controlling switching of a rotation position of the dispensing chute portion, coins received from the upper face of the dispensing chute portion at a first dispensing escrow unit position can be stored inside, coins received from the upper face of the dispensing chute portion at a second dispensing escrow unit position can be sent to the dispensing tray, and coins received from the upper face of the dispensing chute portion at a third dispensing escrow position can be sent to the coin cassette.

According to a coin depositing and dispensing machine of the present invention, when a dispensing instruction including the denominations and number of coins to be dispensed or dispensing amount is received from the outside of the machine body, the dispensing chute portion of the dispensing escrow unit is rotated to the first dispensing escrow unit position, and thus coins are transported and can be stored into the dispensing escrow unit, the coins being fed one by one from accommodating and dispensing portions, transported by the transporting unit and recognized as normal coins by the recognition unit, and coins not recognized as normal coins are transported to the feeding unit and can be prevented from being dispensed.

According to a coin depositing and dispensing machine of the present invention, when a dispensing instruction including the denominations and number of coins to be dispensed or dispensing amount is received from the outside of the machine body, the dispensing chute portion of the dispensing escrow unit is rotated to the first dispensing escrow position, and thus coins are transported to the dispensing escrow unit, the coins being fed one by one from the accommodating and dispensing portions, transported by the transporting unit and recognized as normal coins by the recognition unit, coins not recognized as normal coins are transported to the feeding unit, all coins according to the dispensing instruction regarding the denominations and number of coins to be dispensed or dispensing amount are transported to the dispensing escrow unit, and then the dispensing chute portion of the dispensing escrow unit is rotated to the second dispensing escrow unit position, coins to be dispensed in the dispensing escrow unit are sent to the dispensing tray and can be dispensed, the coins not recognized as normal coins are re-fed one by one by the feeding unit and transported by the transporting unit, coins recognized as normal coins by the recognition unit are transported and can be accommodated into the corresponding accommodating and dispensing portions, and coins not recognized as normal coins are transported to the coin cassette and can be collected.

According to a coin depositing and dispensing machine of the present invention, when a replenishing instruction is received from the outside of the machine body, the chute portion of the escrow unit is rotated to the second rotation position, and thus coins received from the coin receiving port are fed one by one by the feeding unit and transported by the transporting unit, a coin recognized as a normal coin by the recognition unit is transported to the coin cassette and can be collected when the accommodating and dispensing portion for accommodating the corresponding coin is in a full state, or can be transported and accommodated for replenishment into the corresponding accommodating and dispensing portion when the accommodating and dispensing portion is not in the full state, and coins not recognized as normal coins by the recognition unit are transported to the dispensing tray and can be returned.

According to a coin depositing and dispensing machine of the present invention, in addition to the effect of the coin depositing and dispensing machine according to of the invention, when an individual replenishing instruction including information on the denomination of a coin for replenishment is received from the outside of the machine body, after the corresponding coin input slot door is opened and coins put in the replenishment coin input slot from the outside of the machine body are received in the corresponding accommodating and dispensing portion, close of the corresponding replenishment coin input slot door is detected, and thus all coins are fed one by one from the accommodating and dispensing portion and transported to the transporting unit, and then the accommodating and dispensing portion is stopped, coins are fed one by one from the feeding unit and transported by the transporting unit, a coin recognized as a normal coin by the recognition unit is transported to the coin cassette and can be collected when the accommodating and dispensing portion for accommodating the corresponding coin is in a full state, or can be transported and accommodated for replenishment into the corresponding accommodating and dispensing portion when the accommodating and dispensing portion is not in the full state, and coins not recognized as normal coins by the recognition unit are transported to the coin cassette and can be collected.

According to a coin depositing and dispensing machine of the present invention, when an individual replenishing instruction including information on the denomination of a coin for replenishment is received from the outside of the machine body, the corresponding replenishment coin input slot door is opened, coins are received into the replenishment coin input slot from the outside of the machine body and sent to the corresponding accommodating and dispensing portion through a replenishing chute portion, and the corresponding accommodating and dispensing portion can be replenished with coins.

According to a coin depositing and dispensing machine of the present invention, when a dispensing instruction including the denominations and number of coins to be dispensed or dispensing amount is received from the outside of the machine body, coins accommodated in the accommodating and dispensing portions are dispensed one by one and transported by the transporting unit, coins recognized as normal coins to be dispensed by the recognition unit are transported to the dispensing tray and can be dispensed, coins not recognized as normal coins and coins recognized as normal coins but not the coins to be dispensed are transported to the feeding unit, all coins according to the dispensing instruction regarding the denominations and number of coins to be dispensed or dispensing amount are transported to the dispensing tray, and then coins are fed one by one from the feeding unit and transported by the transporting unit, a coin recognized as a normal coin by the recognition unit is transported to the coin cassette and can be collected when the accommodating and dispensing portion for accommodating the corresponding coin is in a full state, or can be transported and accommodated for replenishment into the corresponding accommodating and dispensing portion when the accommodating and dispensing portion is not in the full state, and coins not recognized as normal coins by the recognition unit are transported to the coin cassette and can be collected.

According to a coin depositing and dispensing machine of the present invention, when a collecting instruction is received from the outside of the machine body, the chute portion of the escrow unit is rotated to the second rotation position, and coins accommodated in the accommodating and dispensing portions are fed one by one, transported to the coin cassette by the transporting unit and can be collected.

According to a coin depositing and dispensing machine of the present invention, in addition to the effect of the coin depositing and dispensing machine according to the invention, when an outside collecting instruction is received from the outside of the machine body, coins accommodated in the accommodating and dispensing portions are fed one by one, transported to a collection coin dispensing port by the transporting unit and can be collected.

According to a coin depositing and dispensing machine of the present invention, coins transported by the transporting unit can be sorted to the accommodating and dispensing portions by sorting members in accordance with a result of recognition by the recognition unit.

According to a coin depositing and dispensing machine of the present invention, in addition to the effect of the coin depositing and dispensing machine according to the invention, since coins to be deposited and coins to be dispensed can be transported by a circular coin passage, transporting units of depositing system and dispensing system can be made common to each other; and coins in the coin passage can be reliably transported while being pushed one by one by a plurality of projections of an endless transporting body.

According to a coin depositing and dispensing machine of the present invention, coins can be accommodated with the coins not aligned and can be reliably fed one by one, and structures of the feeding unit and accommodating and dispensing portion can be made common to each other, because a rotary disc, which is rotated, around a rotary axis attached to the machine body, at a position tilted at a predetermined angle in relation to a horizontal direction, and a hopper for accommodating coins received on a surface side of the rotary disc with the coins not aligned are provided in the feeding unit and accommodating and dispensing portion.

### BRIEF DESCRIPTION OF THE DRAWINGS

FIG. 1 is a side view showing an inner structure of a coin depositing and dispensing machine according to an embodiment of the present invention.

FIG. 2 is a perspective view of the coin depositing and dispensing machine viewed from its front face side.

FIG. 3 is a perspective view of the coin depositing and dispensing machine, to which a dispensing tray is attached, viewed from its rear face side.

FIG. 4 is a perspective view of the coin depositing and dispensing machine, to which a machine outside cassette is attached, viewed from the rear face side.

FIG. 5 is a side view showing an inner structure of a coin depositing and dispensing machine of a second specification, the machine including an individual replenishment function.

FIG. 6 is a perspective view of the coin depositing and dispensing machine of the second specification viewed from its rear face side.

FIG. 7 is a front view of an accommodating and dispensing portion of the coin depositing and dispensing machine.

FIG. 8 is an explanatory view showing operation of a pulling-over member in the case where coins are transported in a coin passage of the coin depositing and dispensing machine in one direction.

FIG. 9 is an explanatory view showing operation of the pulling-over member in the case where coins are transported in the coin passage of the coin depositing and dispensing machine in the other direction.

FIG. 10 is a front view of an escrow unit of the coin depositing and dispensing machine.

FIG. 11 is a side view of the escrow unit (a dispensing escrow unit).

FIG. 12 is a cross sectional view of the escrow unit (dispensing escrow unit) viewed from its planar direction.

FIG. 13 is a block diagram of the coin depositing and dispensing machine.

FIG. 14 is an explanatory view showing depositing operation in the case where direct depositing is performed in the coin depositing and dispensing machine.

FIG. 15 is an explanatory view showing coin escrow operation at the time of depositing in the case where a depositing check is performed in the coin depositing and dispensing machine.

FIG. 16 is an explanatory view showing accommodating operation after coin escrow in the case where the depositing check is performed in the coin depositing and dispensing machine.

FIG. 17 is an explanatory view showing returning operation in the case where the direct deposit is performed in the coin depositing and dispensing machine.

FIG. 18 is an explanatory view showing returning operation after coin escrow in the case where the depositing check is performed in the coin depositing and dispensing machine.

FIG. 19 is an explanatory view showing operation from coin counting to escrow at the time of dispensing of the coin depositing and dispensing machine.

FIG. 20 is an explanatory view showing ejecting operation of a coin to be dispensed and returning operation of a coin not recognized as a normal coin after dispensing escrow of the coin depositing and dispensing machine.

FIG. 21 is an explanatory view showing coin taking-in operation after dispensing escrow of the coin depositing and dispensing machine.

FIG. 22 is an explanatory view showing replenishing operation with coins from a coin input slot of the coin depositing and dispensing machine.

FIG. 23 is an explanatory view showing collecting operation to a coin dispensing port of the coin depositing and dispensing machine.

FIG. 24 is an explanatory view showing collecting operation to a coin cassette of the coin depositing and dispensing machine.

FIG. 25 is an explanatory view showing operation of moving coins in the accommodating and dispensing portion at the time of automatic investigation of the coin depositing and dispensing machine.

FIG. 26 is an explanatory view showing operation of counting coins moved at the time of the automatic investigation of the coin depositing and dispensing machine and returning them to the original accommodating and dispensing portion.

FIG. 27 is an explanatory view showing operation of discharging a foreign object remaining in a feeding unit of the coin depositing and dispensing machine.

FIG. 28 is an explanatory view showing operation until coin escrow at the time of replenishment from the rear face of the coin depositing and dispensing machine.

FIG. 29 is an explanatory view showing operation of counting coins temporarily stored at the time of replenishment from the rear face of the coin depositing and dispensing machine and replenishing the accommodating and dispensing portions with coins.

FIG. 30 is an explanatory view showing operation of moving coins in the accommodating and dispensing portion at the time of collection from the rear face of the coin depositing and dispensing machine.

FIG. 31 is an explanatory view showing operation of counting coins moved at the time of collection from the rear face of the coin depositing and dispensing machine and dispensing the coins from a collection coin dispensing port of the rear face.

FIG. 32 is an explanatory view showing operation of moving coins in the accommodating and dispensing portions at the time of dispensing from the rear face of the coin depositing and dispensing machine.

FIG. 33 is an explanatory view showing operation of counting coins moved at the time of dispensing from the rear face of the coin depositing and dispensing machine and dispensing the coins from the collection coin dispensing port of the rear face.

FIG. 34 is a front view showing another escrow unit (dispensing escrow unit).

FIG. 35 is a cross sectional view showing another escrow unit (dispensing escrow unit).

FIG. 36 is a cross sectional view showing still another escrow unit (dispensing escrow unit).

FIG. 37 is a side view showing still another escrow unit (dispensing escrow unit).

### DETAILED DESCRIPTION OF THE INVENTION

Hereinafter, an embodiment of the present invention will be described with reference to the drawings. Moreover, the embodiment is only cited as an example, and does not limit the scope of the present invention.

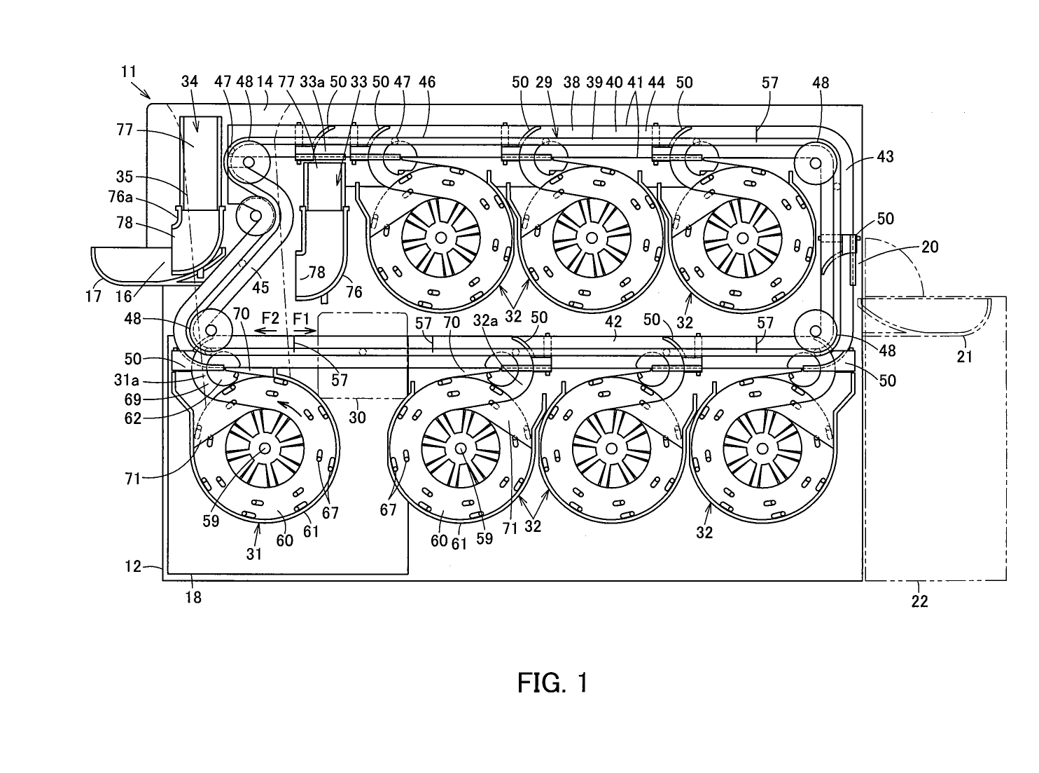

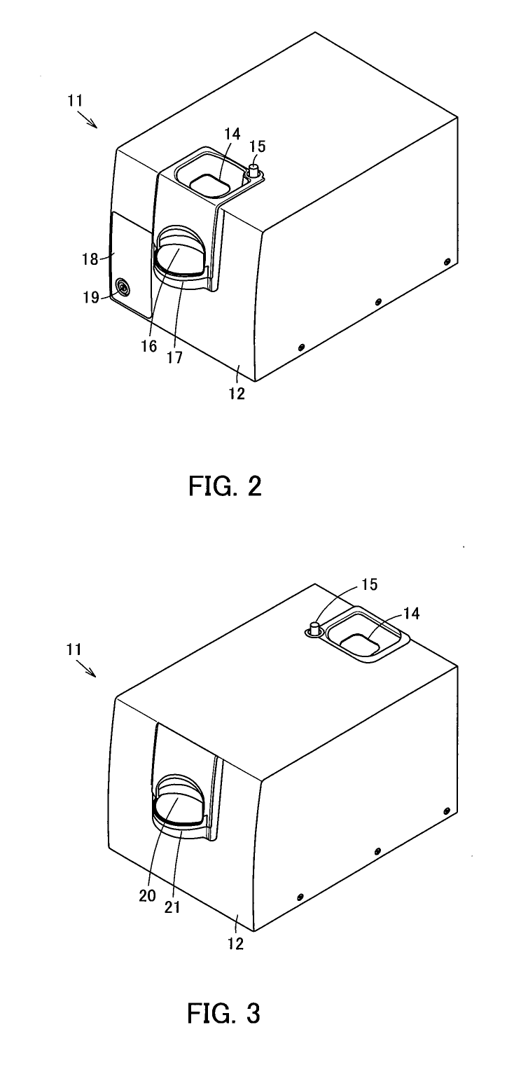

As shown in FIGS. 1 and 2, a coin depositing and dispensing machine 11, which is a coin processing machine, serves as an automatic change dispenser enabling depositing of coins paid by customers and dispensing change to be paid to customers in, for example, a shop.

The coin depositing and dispensing machine 11 includes a machine body 12, a front face (left side in FIGS. 1 and 2) of the machine body 12 is set as an operation face for customers, and a rear face (right side in FIGS. 1 and 2) of the machine body 12 is set as an operation face for cashiers. In this case, a customer deposits coins to be paid and receives dispensed change by himself/herself, it is not required to constantly arrange cashiers for the coin depositing and dispensing machine 11, and a cost reduction is realized in a shop introducing the coin depositing and dispensing machine 11.

Additionally, the front face (left side in FIGS. 1 and 2) of the machine body 12 may be set as an operation face for cashiers, and the rear face (right side in FIGS. 1 and 2) of the machine body 12 may be set as an operation face for customers. In this case, it is required to arrange cashiers for the coin depositing and dispensing machine 11. However, a cashier deposits coins paid by customers and receives change to be paid to customers, and thus delivery and receipt of cash is visually checked by the customer and cashier and can be more reliably performed.

A coin receiving port 14, through which coins are put into the machine body 12, and a deposit starting button 15 for starting depositing operation are disposed at a front upper face of the machine body 12.

A coin dispensing port 16 for dispensing coins to the outside of machine body 12 and a front dispensing tray 17 for receiving the coins dispensed from the coin dispensing port 16 are disposed at the front face of the machine body 12. Further, a coin cassette 18 removable from the machine body 12 is disposed at the front face of the machine body 12. A locking portion 19 for locking/unlocking the coin cassette 18 by key operation with the coin cassette 18 attached to the machine body 12 is provided in the coin cassette 18.

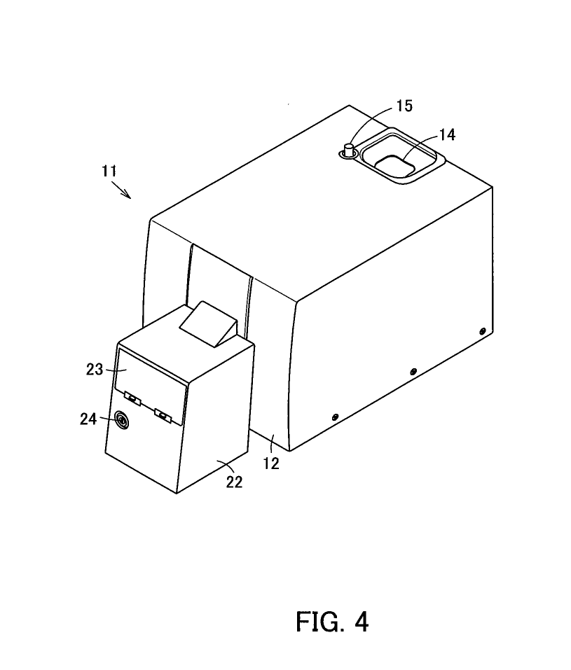

A collection coin dispensing port 20 for dispensing coins is formed in the rear face of the machine body 12. Either a rear dispensing tray 21 (shown in FIG. 3), which receives coins dispensed from the collection coin dispensing port 20, or a machine outside cassette 22 (shown in FIG. 4) capable of collecting coins dispensed from the collection coin dispensing port 20 is attached to the collection coin dispensing port 20 (both of them cannot be attached together). A cassette door 23 for taking out collected coins is openably/closably provided on the machine outside cassette 22, and a locking portion 24 for locking/unlocking the cassette door 23 by key operation is provided in the cassette 22. Moreover, a collection coin dispensing port door (not shown) for opening/closing the collection coin dispensing port 20 is disposed on the collection coin dispensing port 20.

As shown in FIG. 3, in the case where the rear dispensing tray 21 is attached, the rear face side of the machine body may be set as the operation face for customers, and the front face side, at which the coin receiving port 14 for putting coins into the machine body 12 is disposed, may be set as the operation face for cashiers. In this case, counter management can be performed. The counter management indicates management that a cashier receives coins paid by a customer and deposits them into the coin depositing and dispensing machine 11 and in the case where there exists change to be paid to the customer, the customer receives coins dispensed from the coin depositing and dispensing machine 11 by himself/herself. Here, the dispensing tray 17 is not disposed on the front face of the machine body 12, and the dispensing tray 21 is disposed on only the rear face of the machine body 12. In the counter management, a customer is not required to operate the coin depositing and dispensing machine 11 at the time of depositing, and therefore the burden on the customer is reduced.

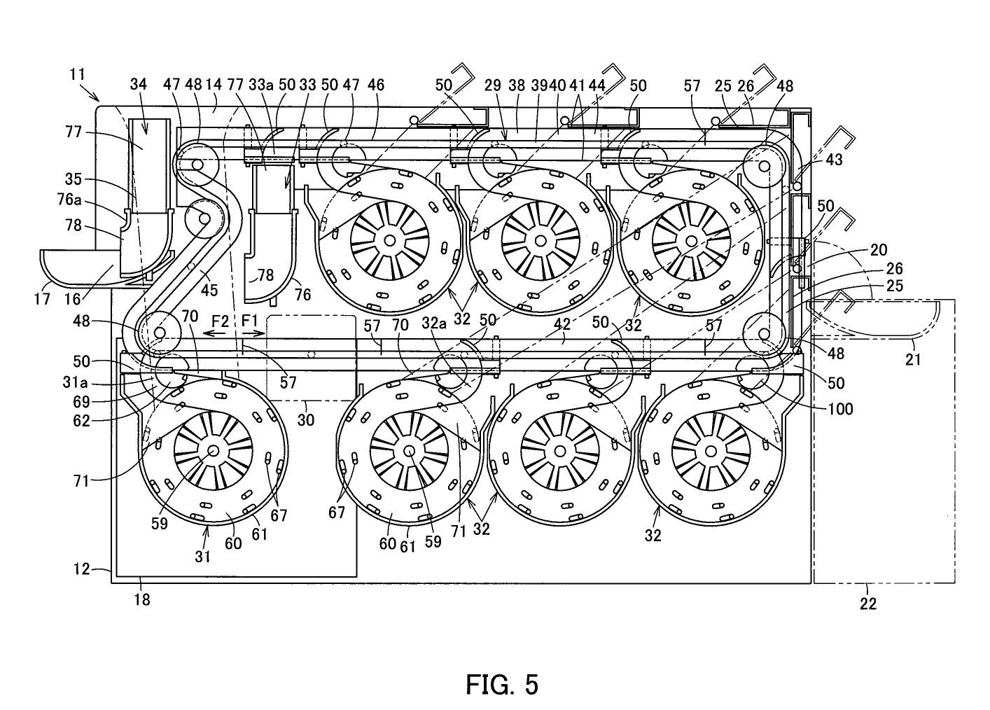

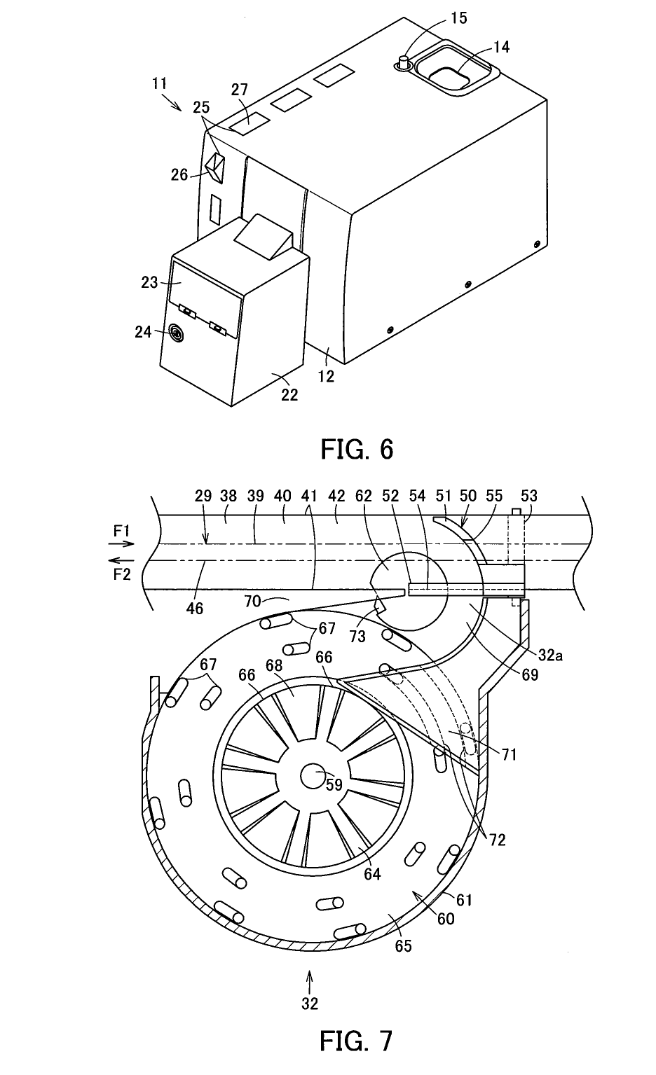

FIG. 1 shows the coin depositing and dispensing machine 11 of a first specification which is a basic specification. FIGS. 5 and 6 show a coin depositing and dispensing machine 11 of a second specification, the machine 11 including an individual replenishment function. In the second specification, a plurality of replenishment coin input slots 25 for putting in coins for replenishment are formed from the upper face to rear face of the machine body 12, and a replenishment coin input slot door 26 for opening/closing each replenishment coin input slot 25 is disposed. Additionally, in the case of the counter management, the dispensing tray 17 is not disposed on the front face of the machine body 12, and the dispensing tray 21 is disposed only on the rear face of the machine body 12.

As shown in FIG. 1, abase (not shown), of which an upper part is tilted, at a predetermined angle, leftward viewed from the front face of the machine body 12, is disposed in the machine body 12, and a circular transporting unit 29 for transporting coins is disposed on a surface side directed upward of the base. A recognition unit 30 for properly selecting and recognizing at least a denomination, authenticity, fatigue, etc., of a coin transported by the transporting unit 29 is disposed on the transporting unit 29, and the following portions, units and port are disposed so as to be connected to the transporting unit 29: a pooling and feeding portion 31 as a feeding unit capable of receiving coins put in the coin receiving port 14, feeding coins one by one to the transporting unit 29 and making coins enter/exit the transporting unit 29 one by one; a plurality of accommodating and dispensing portions 32 for accommodating coins for each denomination and capable of making coins enter/exit the transporting unit one by one; an escrow unit 33 as a coin escrow unit capable of temporarily storing coins to be deposited; a dispensing escrow unit 34 as a coin escrow unit capable of temporarily storing coins to be dispensed; and the collection coin dispensing port 20. A receiving chute 35 for introducing coins put in the coin receiving port 14 to the pooling and feeding portion 31 is disposed between the coin receiving port 14 and pooling and feeding portion 31.

As show in FIGS. 1 and 7, the transporting unit 29 includes a circular coin passage 38 for aligning and guiding coins to be transported, and an endless transporting body 39 for transporting coins in the coin passage 38.

The coin passage 38 includes a passage face 40 which is formed on the surface of the base and with which a surface of a coin comes into contact, and both side guide side plates 41 for guiding a circumference of a coin at both sides of the pas sage face 40. In the coin passage 38, the following portions are formed: a first passage portion 42 provided from the front side to rear side of the machine body 12; a turning passage portion 43 provided along the rear face of the machine body 12 so that the coin passage is turned from a rear end of the first passage portion 42 to the front side of the machine body 12; a second passage portion 44 which is directed from the turning passage portion 43 to the front side of the machine body 12 and has a front end directed to the dispensing escrow unit 34; and a dispensing passage portion 45 provided so as to be directed to the dispensing escrow unit 34 in parallel with the front end of the second passage portion 44 from a front end of the first passage portion 42.

The transporting body 39 is constituted by an endless belt 46, and a plurality of projections 47 are projected from a face, which faces the passage face 40, of the belt 46 at a predetermined pitch in a longitudinal direction of the belt. The belt 46 is stretched by a plurality of pulleys 48 so as to be rotated through a central region of the coin passage 38. A coin is received between the adjacent projections 47 of the belt 46, pushed and transported by the projections 47 by rotation of the belt 46. Additionally, the pulleys 48 are normally and reversely rotated by a motor, and thus the belt 46 is normally and reversely rotated. At the time of depositing, etc., where coins are fed from the pooling and feeding portion 31 and accommodated in the accommodating and dispensing portions 32, the belt 46 is rotated in a first direction (hereinafter, referred to as a depositing and transporting direction F1) which is a normal direction where coins are moved from the front side to rear side in the first passage portion 42. On the other hand, at the time of dispensing, etc., where coins are fed from the accommodating and dispensing portions 32 and dispensed to the coin dispensing port 16, the belt 46 is rotated in a second direction (hereinafter, referred to as a dispensing and transporting direction F2) reverse to the depositing and transporting direction F1. Therefore, normal and reverse rotation of the belt 46 enables coins in the coin passage 38 to be transported in normal and reverse directions.

At the lower side of the first passage portion 42 of the coin passage 38, the pooling and feeding portion 31 is disposed on the front side and the plurality of, for example, three accommodating and dispensing portions 32 are disposed, along the first passage portion 42, behind the pooling and feeding portion 31. The recognition unit 30 is disposed between the pooling and feeding portion 31 and foremost accommodating and dispensing portion 32. Additionally, at the lower side of the second passage portion 44, the plurality of, for example, three accommodating and dispensing portions 32 are disposed along the second passage portion 44, and the escrow unit 33 is disposed in front of the accommodating and dispensing portions 32. The dispensing escrow unit 34 is disposed facing the front end of the second passage portion 44 and a front end of the dispensing passage portion 45.

Additionally, a coin inlet/outlet 31a of the pooling and feeding portion 31 and a coin inlet/outlet 32a of each accommodating and dispensing portion 32, through which coins can enter/exit the coin passage 38, are formed in a manner that a part of each of the corresponding guide side plates 41 on the lower side of each passage portions 42 and 44 is opened. A coin inlet 33a of the escrow unit 33 capable of receiving coins from the coin passage 38 is formed in a manner that a part of the guide side plate 41 on the lower side of the second passage portion 44 is opened. The collection coin dispensing port 20 capable of receiving coins from the coin passage 38 is formed in a manner that a part of the guide side plate 41 on the rear side of the turning passage portion 43 is opened.

Sorting members 50, which selectively sort coins in accordance with making coins enter/exit the coin inlet/outlet 31a and each coin inlet/outlet 32a or making coins transported by the transporting unit 29 pass to the downstream side in a transporting direction, are disposed at the coin inlet/outlet 31a of the pooling and feeding portion 31 and each coin inlet/outlet 32a of the accommodating and dispensing portion 32 aside of the coin passage 38. Further, sorting members 50, which selectively sort coins in accordance with diverging coins or making coins transported by the transporting unit 29 pass to the downstream side in the transporting direction, are disposed at the coin inlet 33a of the escrow unit 33 and collection coin dispensing port 20. These sorting members 50 have the same basic structure and operation of sorting coins, except for a direction, etc.

The sorting member 50 for accommodating and dispensing portions 32 will be described with reference to FIG. 7. The sorting member 50 includes: a coin guiding portion 51 for guiding coins to the coin inlet/outlet 32a; a closing portion 52 for preventing coins from entering the coin inlet/outlet 32a; and a holding portion 53 for holding the coin guiding portion 51 and closing portion 52 swingable.

The coin guiding portion 51 is provided so that one side, at which the coin inlet/outlet 32a side of the coin guiding portion 51 is located, in a width direction crossing the pas sage direction of the coin passage 38, a lower side, of the coin guiding portion 51 is tilted, at a predetermined angle, to the downstream side in a transporting direction when the transporting unit 29 is driven in the depositing and transporting direction F1, in relation to the other side, which is located opposite from the coin inlet/outlet 32a, in the width direction of the coin passage 38, an upper side, of the coin guiding portion 51. Additionally, the coin guiding portion 51 is provided in the shape of a recessed-face facing the upstream side in the transporting direction when the transporting unit 29 is driven in the depositing and transporting direction F1.

A guide face 54, which becomes flush with the lower guide side plate 41 and guides the circumference of a coin when the closing portion 52 is closed, is provided in the closing portion 52.

The holding portion 53 is located at the downstream side in relation to the coin guiding portion 51 and closing portion 52 in the depositing and transporting direction F1, turnable around the axis as a fulcrum in the width direction of the coin passage 38, and turned by an electric driving unit such as a solenoid. When coins are sorted from the coin passage 38 to the accommodating and dispensing portion 32 and fed from the accommodating and dispensing portion 32 to the coin passage 38, the coin guiding portion 51 is projected from the passage face 40 of the coin passage 38 and the sorting member 50 is located at a coin sorting position where the coin inlet/outlet 32a is opened by the closing portion 52. On the other hand, when coins are not sorted from the coin passage 38 to the accommodating and dispensing portion 32 and are not fed from the accommodating and dispensing portion 32 to the coin passage 38, the coin guiding portion 51 is retracted under the passage face 40 of the coin passage 38 and the sorting portion 50 is located at a coin passing position where the coin inlet/outlet 32a is closed by the closing portion 52. An opening, through which the coin guiding portion 51 enters/exits the coin passage 38, is formed in the passage face 40 of the coin passage 38. A groove portion 55 for preventing the coin guiding portion 51 projecting from the coin passage 38 from interfering with the belt 46 is formed in the coin guiding portion 51 of the sorting member 50.

Moreover, each of the sorting members 50 of the pooling and feeding portion 31, escrow unit 33 and collection coin dispensing port 20 includes the coin guiding portion 51, closing portion 52 and holding portion 53 similar to those of the sorting member 50 of the accommodating and dispensing portion 32, and is driven by an electric driving unit. Additionally, these sorting members 50 have the same basic structure and operation of sorting coins one by one to the transporting unit 29, except for a direction in the transporting direction.

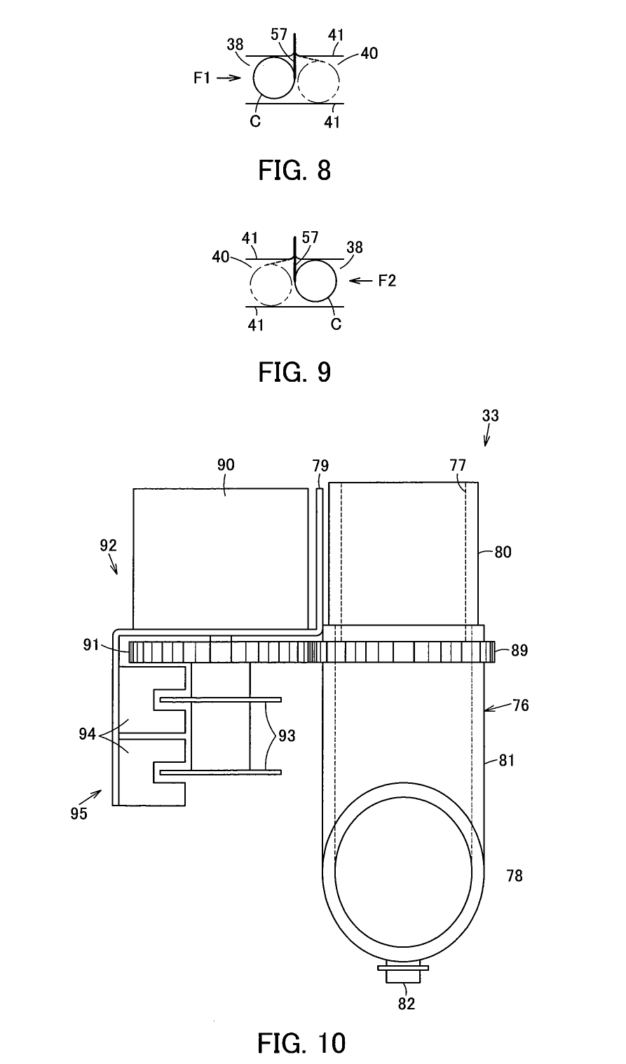

Additionally, in the coin passage 38, pulling-over members 57 for pulling coins transported by the transporting unit 29 over to the lower guide side plate 41 are disposed at both sides of the recognition unit 30 of the first passage portion 42 and on the rear sides of the passage portions 42, 44 connected to the turning passage portion 43. As shown in FIGS. 8 and 9, the pulling-over member 57 is constituted by a sheet-shaped elastic plate spring, one end of the pulling-over member 57 is attached to the upper guide side plate 41, the other end thereof is a free end and projected into the coin passage 38, and a position, where the pulling-over member 57 orthogonally projects from the upper guide side plate 41 of the coin passage 38 into the coin passage 38, is defined as a constant position. In the upper guide side plate 41, both sides of a position, where a base end of the pulling-over member 57 is attached, is curvedly formed so as to facilitate elastic deformation of the pulling-over member 57 in the transporting direction.

As shown in FIG. 8, with use of a spring effect of an elastic body, the pulling-over member 57 is pushed by a coin moving in the depositing and transporting direction F1 at the time of depositing, etc., and thus pushes the coin against the lower guide side plate 41 while being elastically deformed to the downstream side in the transporting direction and returns to the constant position after passing of the coin. On the other hand, as shown in FIG. 9, the pulling-over member 57 is pushed by a coin moving in the dispensing and transporting direction F2 at the time of dispensing, etc., and thus pushes the coin against the lower guide side plate 41 while being elastically deformed to the downstream side in the transporting direction and returns to the constant position after passing of the coin. Therefore, in the coin passage 38 for bidirectionally transporting coins, pulling-over of coins can be reliably performed by a simple constitution. Further, since the pulling-over member 57 is arranged at each of the above-mentioned positions, coins can be reliably recognized by the recognition unit 30 and coins after change of the transporting direction at the turning passage portion 43 can be reliably sorted by each sorting member 50.

FIG. 7 shows the structure of the accommodating and dispensing portion 32 disposed aside of the first pas sage portion 42. The accommodating and dispensing portion 32 includes: a rotary disc 60 rotatable around a rotary axis 59 at a position tilted at a predetermined angle in relation to a horizontal direction; a hopper 61 for pooling coins between the hopper 61 and a surface side of the rotary disc 60; a delivering disc 62 arranged in the vicinity of the coin inlet/outlet 32a; and the like.

Viewing from the front face of the machine body 12, the rotary disc 60, by the rotary axis 59 rotatably attached to the machine body 12, is tilted rightward in relation to the horizontal direction, has a left side higher than a right side, and is disposed so that the surface of the rotary disc 60 is directed to the right upper side of the machine body 12. The rotary disc 60 is interlocked with the belt 46 and delivering disc 62, and rotation-driven by a motor in a feeding and rotating direction (indicated by an arrow in FIG. 1) of feeding coins to the coin pas sage 38. The rotary disc 60 may be made rotatable in a reverse feeding and rotating direction reverse to the feeding and rotating direction so that a coin jam is removed in the occurrence of a coin jam.

A circular high portion 64 is formed at the center of the surface of the rotary disc 60, and an annular low portion 65 is formed at an outer circumferential region of the high portion 64. Stage-shaped coin circumference holding portions 66, each which has a size slightly smaller than the thickness of the smallest coin among coins to be handled and each on which a circumference of one coin is mounted in its thickness direction, are provided between the high portion 64 and low portion 65 of the rotary disc 60.

A plurality of picking-up members 67 projecting from the surface of the rotary disc 60 are arranged on the low portion 65 at a predetermined pitch in two lines in inner and outer circumferential directions. When the rotary disc 60 is rotated in the feeding and rotating direction, each picking-up member 67 on the inner circumferential side holds one coin between the picking up members 67 and the coin circumference holding portion 66 and picks up the coin to an upper region of the rotary disc 60, and each picking-up member 67 on the outer circumferential side pushes the coin, which is picked up to the upper region of the rotary disc 60 by each picking-up member 67 on the inner circumferential side, to the coin inlet/outlet 32a and delivers it to the delivering disc 62.

The coin circumference holding portion 66 is provided for each position where one coin can be held between the coin circumference holding portion 66 and each picking-up member 67. Therefore, the plurality of coin circumference holding portions 66 are provided in the circumferential direction. A sliding-down portion 68 is formed between the coin circumference holding portions 66, the sliding-down portion 68 sliding coins, which cannot be held between the picking-up member 67 and coin circumference holding portion 66, downward on a tilted surface constituted by a difference in level between the high portion 64 and low portion 65.

A guide passage 69 for feeding coins picked up to the upper region of the rotary disc 60 by the picking-up members 67 to the coin inlet/outlet 32a is formed at the upper region of the rotary disc 60. The guide passage 69 is formed between the passage face 40, which is flush with the surface of the rotary disc 60, of the coin passage 38 and upper and lower guide members 70, 71.

The upper guide member 70 is formed from the upper region of the rotary disc 60 to one edge side of the coin inlet/outlet 32a so as to be projected from the surfaces of the rotary disc 60 and passage face 40.

The lower guide member 71 is provided from the coin circumference holding portion 66 side to the other edge side of the coin inlet/outlet 32a in a state of facing a surface of the low portion 65 at an interval that no coins enter. An inner edge, which faces the inside of the guide passage 69, of the guide member 71 is curvedly formed so as to continue to the coin guiding portion 51 of the sorting member 50. A groove portion 72, through which each rotationally moved picking-up member 67 passes, is formed in a surface, which faces the low portion 65, of the guide member 71. By the guide member 71, coins picked up by the picking-up members 67 are received from the coin circumference holding portions 66 and guided to the coin inlet/outlet 32a.

The hopper 61 faces and covers the surface side of the rotary disc 60, and is opened upward so as to receive coins from the coin inlet/outlet 32a.

The delivering disc 62 is rotatably arranged in a space, which is obtained by notching a part of the guide passage 69 and a part of the coin passage 38, so that a surface of the delivering disc 62 is flush with the rotary disc 60 and passage face 40. A projection 73 for coming into contact with coins and feeding coins from the rotary disc 60 side to the coin pas sage 38 is projected on an outer circumference of the delivering disc 62. The delivering disc 62 is interlocked with the belt 46 of the coin passage 38, and rotated, when the belt 46 moves in the dispensing and transporting direction F2, in a feeding and rotating direction where the projection 73 is moved from the coin inlet/outlet 32a into the coin passage 38, that is, in a feeding and rotating direction where coins are fed from the rotary disc 60 side to the coin passage 38 by the projection 73, and rotated, when the belt 46 moves in the depositing and transporting direction F1, in a reverse feeding and rotating direction where the projection 73 moves from the coin passage 38 side into the coin inlet/outlet 32a.

Moreover, since the transporting direction of coins of the first passage portion 42 is opposite to that of the second passage portion 44, a direction of each accommodating and dispensing portion 32 provided aside of the second passage portion 44 is opposite to that provided aside of the first passage portion 42, and both the accommodating and dispensing portions 32 have the same basic structure. Additionally, although a direction of the pooling and feeding portion 31 is opposite to that of each accommodating and dispensing portion 32 provided aside of the first passage portion 42, both the portions have the same basic structure. The delivering disc 62 is rotated in the feeding and rotating direction when the belt 46 moves in the depositing and transporting direction F1, and rotated in the reverse feeding and rotating direction when the belt 46 moves in the dispensing and transporting direction F2. Additionally, a foreign object discharge gate (not shown) for discharging a foreign object, which the rotary disc 60 cannot feed and remains in the hopper 61, is openably/closably disposed at a lower part of the hopper 61 of the pooling and feeding portion 31.

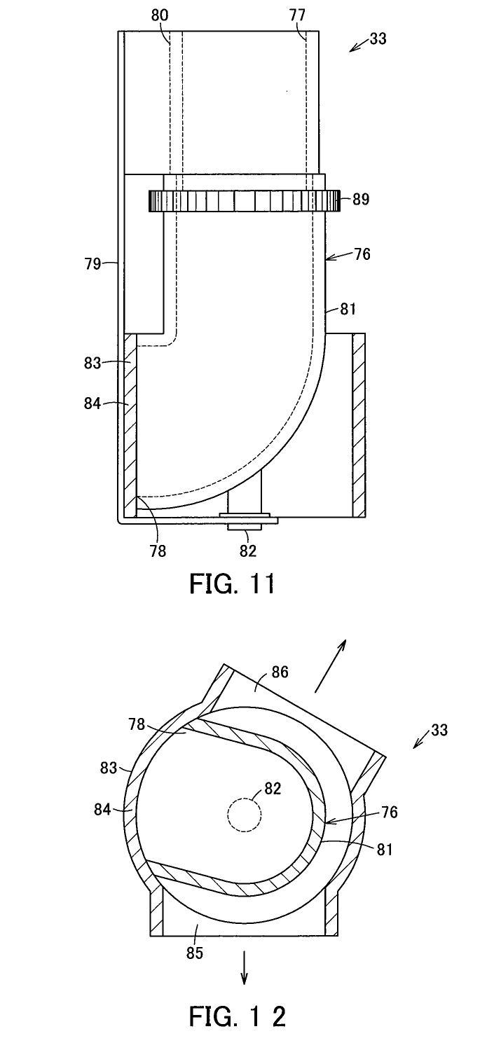

As shown in FIGS. 1, 10 to 12, the escrow unit 33 is disposed above the coin cassette 18 and pooling and feeding portion 31, and includes a chute portion 76 as a coin storing member. The chute portion 76 is hollow and cylindrical, a horizontal opening 77 for receiving coins sorted from the coin passage 38 by the sorting member 50 is formed in an upper region of the chute portion 76, an opening 78 opened sideward is formed in a lower region of the chute portion 76, and the chute portion 76 is formed so that its lower side is curved toward the opening 78.

The chute portion 76 has an upper cylindrical portion 80 attached to the machine body 12 by an attaching member 79, and a lower cylindrical portion 81 rotatably attached to a lower side of the upper cylindrical portion 80. An axis portion 82 rotatably attached to the attaching member 79 is projected on a lower part of the lower cylindrical portion 81. Therefore, the lower cylindrical portion 81 of the chute portion 76 is rotatable around a vertical axis passing through the center of the upper cylindrical portion 80 and center of the axis portion 82.

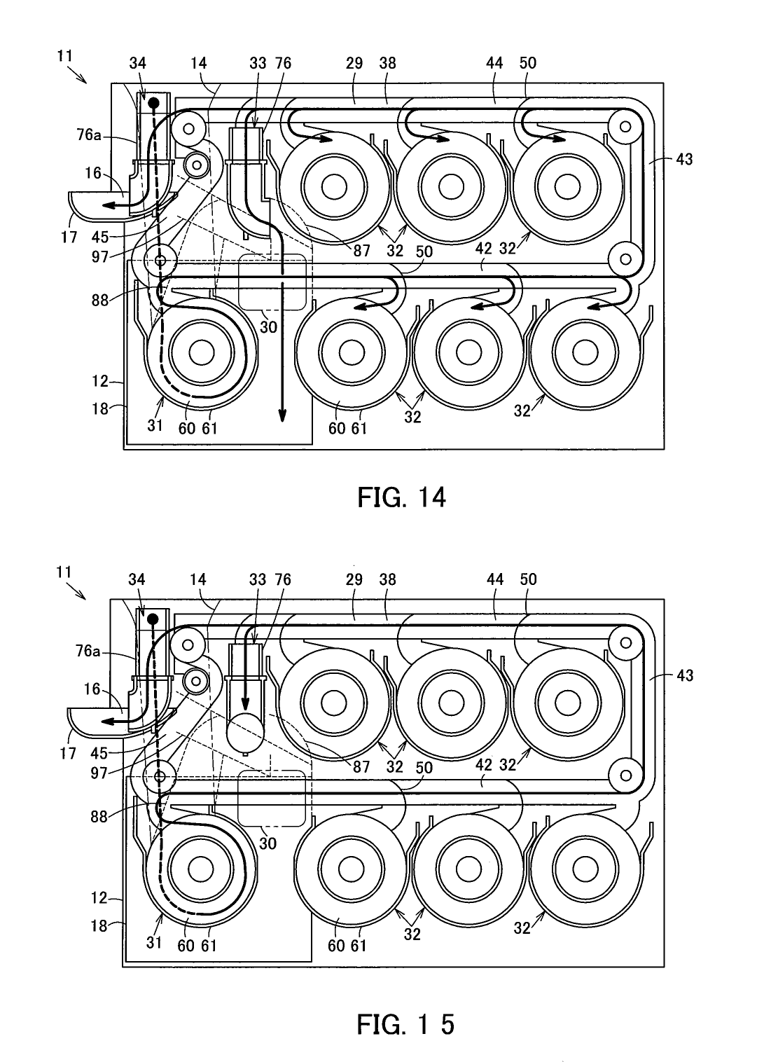

A closing member 83 capable of closing the opening 78 is disposed on a circumference of a rotation region in which the opening 78 in the lower region of the chute portion 76 is rotated. A closing portion 84 is provided in the closing member 83, the closing portion 84 closing the opening 78 in the lower region when the chute portion 76 is located at a first rotation position which is a storage position as a predetermined rotation position. A first ejection port 85 is formed at one side of the closing portion 84, the first ejection port 85 from which coins are ejected by opening the opening 78 of the chute portion 76 when the chute portion 76 is rotated from the first rotation position to a second rotation position in one side direction. A second ejection port 86 is formed at the other side of the closing portion 84, the second eject port 86 from which coins are ejected by opening the opening 78 of the chute portion 76 when the chute portion 76 is rotated from the first rotation position to a third rotation position in the other side direction. As shown in FIG. 14, a first chute 87 as a collection chute for guiding coins ejected from the chute portion 76 rotated to the second rotation position to the coin cassette 18 is arranged opposite to the first ejection port 85. A second chute 88 as an accommodation return chute for guiding coins ejected from the chute portion 76 rotated to the third rotation position to the pooling and feeding portion 31 is disposed at the second eject port 86.

A gear 89 is formed on an upper circumferential face of the lower cylindrical portion 81 of the chute portion 76, and a driving gear 91, which is rotation-driven by a motor 90 attached to the attaching member 79, is meshed with the gear 89. A rotation-driving unit 92 for rotating the chute portion 76 to each rotation position is constituted by the gears 89, 91, motor 90, etc.

A plurality of detecting plates 93 are attached coaxially with the driving gear 91, and a plurality of sensors 94 for detecting a rotation position for each detecting plate 93 are attached to the attaching member 79. A rotation position detecting unit 95 for detecting the rotation position of the chute portion 76 is constituted by the detecting plates 93 and sensors 94, etc.

The dispensing escrow unit 34 has the same basic structure as that of the escrow unit 33, and includes: a dispensing chute portion 76a as a coin storing member associated with the chute portion 76; a dispensing chute portion rotation-driving unit 92a associated with the closing member 83 and rotation-driving unit 92; a dispensing chute portion rotation position detecting unit associated with the rotation position detecting unit 95; and the like.

The dispensing escrow unit 34 is disposed above the dispensing tray 17, and can, from its upper part, receive coins ejected from the second passage portion 44 and dispensing pas sage portion 45 of the coin passage 38. Moreover, depending on a position of the dispensing chute portion 76a, the coins ejected from the second passage portion 44 and dispensing pas sage portion 45 of the coin passage 38 may be received from an opening provided in the side of an upper cylindrical portion 80 of the dispensing chute portion 76a in place of an opening 77 provided in an upper face of the upper cylindrical portion 80.

A closing portion 84 is provided in a closing member 83, the closing portion 84 closing an opening 78 in a lower region of the dispensing chute portion 76a when the dispensing chute portion 76a is located at a first rotation position which is a storage position as a predetermined rotation position. A first ejection port 85 is formed at one side of the closing portion 84, the first ejection port 85 from which coins are ejected by opening the opening 78 of the dispensing chute portion 76a when the dispensing chute portion 76a is located at a second rotation position by being rotated from the first rotation position in one side direction. A second eject port 86 is formed at the other side of the closing portion 84, the second eject port 86 from which coins are ejected by opening the opening 78 of the dispensing chute portion 76a when the dispensing chute portion 76a is located at a third position by being rotated from the first rotation position in the other side direction.

Regarding the dispensing chute portion 76a, a position where the opening 78 faces the closing portion 84 of the closing member 83 is defined as a first dispensing escrow unit position for storing coins inside, the coins being received from an upper face of the dispensing chute portion 76a, a position where the opening 78 faces the first eject port 85 of the closing member 83 is defined as second dispensing escrow unit position for sending coins to the dispensing tray 17, the coins being received from the upper face of the dispensing chute portion 76a, and a position where the opening 78 faces the second eject port 86 of the closing member 83 is defined as a third dispensing escrow unit position for sending coins to the coin cassette 18, the coins being received from the upper face of the dispensing chute portion 76a.

As shown in FIG. 14, a third chute 97 as a collection chute for guiding coins, which are ejected from the dispensing chute portion 76a rotated to the third dispensing escrow unit position, to the coin cassette 18 is arranged opposite to the second eject port 86.

In the case of the coin depositing and dispensing machine 11, including the individual replenishment function, of the second specification shown in FIGS. 5 and 6, each replenishment coin input slot 25 is associated with each accommodating and dispensing portion 32, and a plurality of replenishment chute portions 100 are disposed each which guides coins put in from each replenishment coin input slot 25 to the associated accommodating and dispensing portion 32.

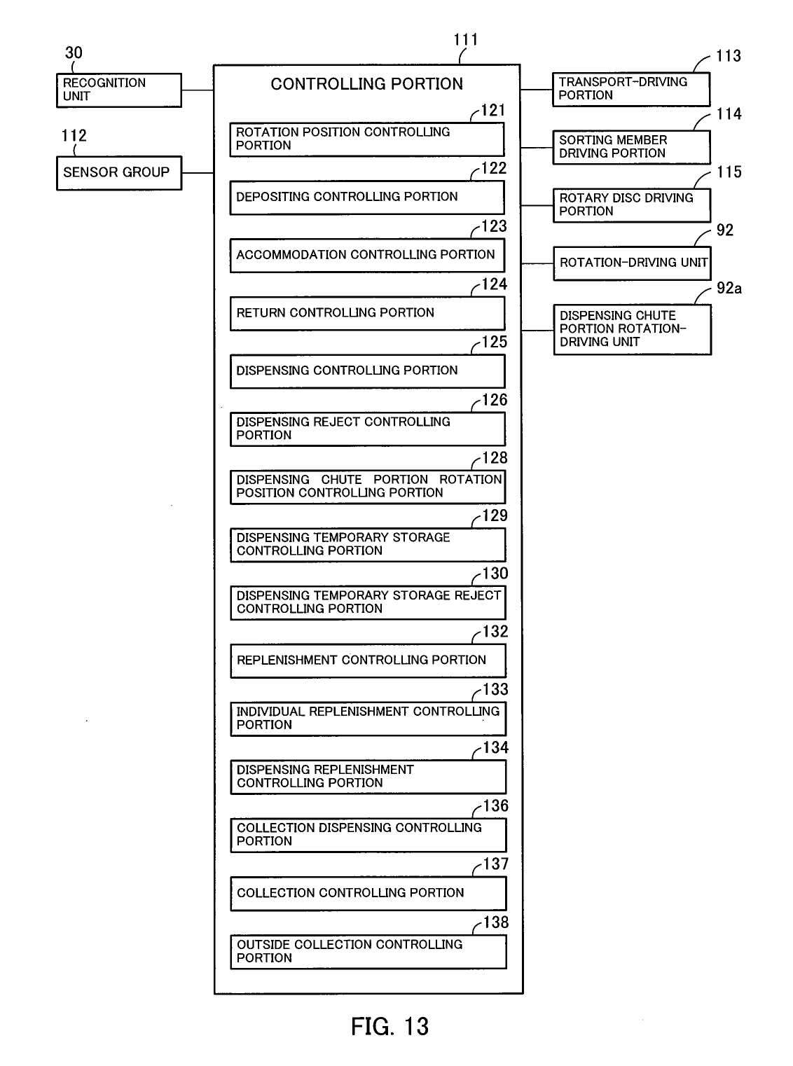

FIG. 13 shows a controlling portion 111 for controlling the coin depositing and dispensing machine 11.

Signals are input into the controlling portion 111 from the recognition unit 30, a sensor group 112 including various sensors and a detecting unit disposed in the coin depositing and dispensing machine 11, and the like, and the controlling portion 111 controls: a transport-driving unit 113 using motors or the like for driving the belt 46 of the coin passage 38 and the delivering disc 62; a sorting member driving portion 114 using a solenoid, motor or the like for driving each sorting member 50; a rotary disc driving portion 115 using a motor or the like for driving each rotary disc 60; the rotation-driving unit 92 of the escrow unit 33; the dispensing chute portion rotation-driving unit 92a of the dispensing escrow unit 34; and the like.

As a sensor of the sensor group 112, the following sensors are cited: a plurality of sensors which are provided on the coin passage 38 to detect coins transported in the coin passage 38; sensors which are provided on the pooling and feeding portion 31 and each accommodating and dispensing portion 32 to detect presence/absence and entrance/exit of a coin; the sensor 94 of the rotation position detecting unit 95 of the escrow unit 33; a sensor of a rotation position detecting unit of the dispensing escrow unit 34; and the like.

The controlling portion 111 has various functions of controlling the coin depositing and dispensing machine 11, and some functions having features will be described below.

In a function of a rotation position controlling portion 121, by the rotation-driving unit 92 of the escrow unit 33, the rotation position of the chute portion 76 controls switching to a storage position for storing coins received inside from an upper face of the chute portion 76, or an ejecting position for directly ejecting coins from a lower face of the chute portion 76, the coins being received inside from the upper face of the chute portion 76 without storage. More specifically, the rotation position controlling portion 121 controls switching of the rotation position of the chute portion 76 to the first rotation position which is the storage position for storing coins inside, which are received from the upper face of the chute portion 76, the second rotation position for sending coins received from the upper face of the chute portion 76 to the coin cassette 18, or the third rotation position for sending coins received from the upper face of the chute portion 76 to the pooling and feeding portion 31.

In a function of a depositing controlling portion 122, when a depositing instruction is received from the outside of the machine body 12, the chute portion 76 of the escrow unit 33 is rotated to the first rotation position, the pooling and feeding portion 31 and transporting unit 29 are driven, coins received in the coin receiving port 14 are fed one by one by the pooling and feeding portion 31 and transported by the transporting unit 29, coins recognized as normal coins by the recognition unit 30 are transported to the escrow unit 33, and coins not recognized as normal coins are transported to the dispensing tray 17.

In a function of an accommodation controlling portion 123, when an accommodating instruction is received from the outside of the machine body 12, the chute portion 76 of the escrow unit 33 is rotated to the third rotation position, coins stored in the escrow unit 33 are sent to the pooling and feeding portion 31, the pooling and feeding portion 31 and transporting unit 29 are driven, the coins sent to the pooling and feeding portion 31 are fed one by one by the pooling and feeding portion 31 and transported by the transporting unit 29, a coin recognized as a normal coin by the recognition unit 30 is transported to the coin cassette 18 when the accommodating and dispensing portion 32 for accommodating the corresponding coin is in a full state, or transported to the corresponding accommodating and dispensing portion 32 when the accommodating and dispensing portion is not in the full state, and coins not recognized as normal coins by the recognition unit 30 are transported to the coin cassette 18.

In a function of a return controlling portion 124, when a returning instruction is received from the outside of the machine body 12, the chute portion 76 of the escrow unit 33 is rotated to the third rotation position, coins stored in the escrow unit 33 are sent to the pooling and feeding portion 31, the pooling and feeding portion 31 and transporting unit 29 are driven, the coins sent to the pooling and feeding portion 31 are fed one by one by the pooling and feeding portion 31 and transported by the transporting unit 29, and all coins stored in the escrow unit 33 are transported to the dispensing tray 17.

In a function of a dispensing controlling portion 125, when a dispensing instruction including the denominations and number of coins to be dispensed or dispensing amount is received from the outside of the machine body 12, the pooling and feeding portion 31, transporting unit 29 and accommodating and dispensing portions 32 are driven, coins accommodated in the accommodating and dispensing portions 32 are dispensed one by one and transported by the transporting unit 29, coins recognized as normal coins by the recognition unit 30 are transported to the dispensing tray 17, and coins not recognized as normal coins are transported to the pooling and feeding portion 31.

In a function of a dispensing reject controlling portion 126, when a dispensing instruction including the denominations and number of coins to be dispensed or dispensing amount is received from the outside of the machine body 12, the chute portion 76 of the escrow unit 33 is rotated to the second rotation position, the pooling and feeding portion 31, transporting unit 29 and accommodating and dispensing portions 32 are driven, coins accommodated in the accommodating and dispensing portions 32 are dispensed one by one and transported by the transporting unit 29, coins recognized as normal coins by the recognition unit 30 are transported to the dispensing tray 17, coins not recognized as normal coins are transported to the pooling and feeding portion 31, and re-fed one by one from the pooling and feeding portion 31 and transported by the transporting unit 29 after all coins according to the dispensing instruction regarding the denominations and number of coins to be dispensed or dispensing amount are transported to the dispensing tray 17, coins recognized as normal coins by the recognition unit 30 are transported to the corresponding accommodating and dispensing portions 32, and coins not recognized as normal coins are transported to the coin cassette 18.

In a function of a dispensing chute portion rotation position controlling portion 128, by the dispensing chute portion rotation-driving unit 92a of the dispensing escrow unit 34, the rotation position of the dispensing chute portion 76a controls switching to the storage position for storing coins received inside from the upper face of the dispensing chute portion 76a, or an ejecting position for directly ejecting coins received inside from the upper face of the dispensing chute portion 76a from the lower face without storage. More specifically, the dispensing chute portion rotation position controlling portion 128 controls switching of the rotation position of the dispensing chute portion 76a to the first dispensing escrow unit position for storing coins inside, which are received from the upper face of the dispensing chute portion 76a, the second dispensing escrow unit position which is one of the ejecting positions for sending coins, which are received from the upper face of the dispensing chute portion 76a, to the dispensing tray 17, or the third dispensing escrow unit position which is another ejecting position for sending coins, which are received from the upper face of the dispensing chute portion 76a, to the coin cassette 18.

In a function of a dispensing escrow controlling portion 129, when a dispensing instruction including the denominations and number of coins to be dispensed or dispensing amount is received from the outside of the machine body 12, the dispensing chute portion 76a of the dispensing escrow unit 34 is rotated to the first dispensing escrow unit position, the pooling and feeding portion 31, transporting unit 29 and accommodating and dispensing portions 32 are driven, coins accommodated in the accommodating and dispensing portion 32 are fed one by one and transported by the transporting unit 29, coins recognized as normal coins by the recognition unit 30 are transported to the dispensing escrow unit 34, and coins not recognized as normal coins are transported to the pooling and feeding portion 31.

In a function of a dispensing escrow reject controlling portion 130, when a dispensing instruction including the denominations and number of coins to be dispensed or dispensing amount is received from the outside of the machine body 12, the dispensing chute portion 76a of the dispensing escrow unit 34 is rotated to the first dispensing escrow unit position, the pooling and feeding portion 31, transporting unit 29 and accommodating and dispensing portions 32 are driven, coins accommodated in the accommodating and dispensing portion 32 are fed one by one and transported by the transporting unit 29, coins recognized as normal coins by the recognition unit 30 are transported to the dispensing escrow unit 34, coins not recognized as normal coins are transported to the pooling and feeding portion 31, all coins according to the dispensing instruction regarding the denominations and number of coins to be dispensed or dispensing amount are transported to the dispensing escrow unit 34, and then the dispensing chute portion 76a of the dispensing escrow unit 34 is rotated to the second dispensing escrow unit position, coins to be dispensed in the dispensing escrow unit 34 are sent to the dispensing tray 17, the coins not recognized as normal coins are re-fed one by one from the pooling and feeding portion 31 and transported by the transporting unit 29, coins recognized as normal coins by the recognition unit 30 are transported to the corresponding accommodating and dispensing portions 32, and coins not recognized as normal coins are transported to the coin cassette 18.

Ina function of a replenishment controlling portion 132, when a replenishing instruction is received from the outside of the machine body 12, the chute portion 76 of the escrow unit 33 is rotated to the second rotation position, the pooling and feeding portion 31 and transporting unit 29 are driven, coins for replenishment received from the coin receiving port 14 are fed one by one by the pooling and feeding portion 31 and transported by the transporting unit 29, a coin for replenishment recognized as a normal coin by the recognition unit 30 is transported to the coin cassette 18 when the accommodating and dispensing portion 32 for accommodating the coin of the corresponding denomination is in a full state, or transported to the corresponding accommodating and dispensing portion 32 when the accommodating and dispensing portion is not in the full state, and coins not recognized as normal coins by the recognition unit 30 are transported to the dispensing tray 17.

In a function of an individual replenishment controlling portion 133, when an individual replenishing instruction including information on the denomination of a coin for replenishment is received from the outside of the machine body 12, after the corresponding replenishment coin input slot door 26 is opened and coins put in the replenishment coin input slot 25 from the outside of the machine body 12 are received by the corresponding accommodating and dispensing portion 32, close of the replenishment coin input slot door 26 is detected, and thus the transporting unit 29 and accommodating and dispensing portion 32 are driven, coins are fed one by one from the accommodating and dispensing portion 32 and transported to the pooling and feeding portion 31 by the transporting unit 29, all coins in the accommodating and dispensing portion 32 are fed, and then the accommodating and dispensing portion 32 is stopped and the pooling and feeding portion 31 and transporting unit 29 are driven, coins are fed one by one from the pooling and feeding portion 31 and transported by the transporting unit 29, a coin recognized as a normal coin by the recognition unit 30 is transported to the coin cassette 18 when the accommodating and dispensing portion 32 for accommodating the coin of the corresponding denomination is in a full state, or transported to the corresponding accommodating and dispensing portion 32 when the accommodating and dispensing portion is not in the full state, and coins not recognized as normal coins by the recognition unit 30 are transported to the coin cassette 18. Moreover, in the case where an individual replenishing instruction includes information on the number of coins for individual replenishment, or the number of coins for replenishment is designated from the outside of the machine body 12 separately after an individual replenishing instruction, a controlling method is applicable that opens the corresponding replenishment coin input slot door 26, detects close of the replenishment coin input slot door 26 after coins are put in the replenishment coin input slot 25, and thus completes the individual replenishment.

In this case, time for replenishment can be reduced, because a series of operations becomes unnecessary where the transporting unit 29 and accommodating and dispensing portion 32 are driven, coins are fed one by one from the accommodating and dispensing portion 32 and transported to the pooling and feeding portion 31 by the transporting unit 29, all coins in the accommodating and dispensing portion 32 are fed, and then the accommodating and dispensing portion 32 is stopped and the pooling and feeding portion 31 and transporting unit 29 are driven, coins are fed one by one from the pooling and feeding portion 31 and transported by the transporting unit 29, a coin recognized as a normal coin by the recognition unit 30 is transported to the coin cassette 18 when the accommodating and dispensing portion 32 for accommodating the coin of the corresponding denomination is in a full state, or transported to the corresponding accommodating and dispensing portion 32 when the accommodating and dispensing portion is not in the full state, and coins not recognized as normal coins by the recognition unit 30 are transported to the coin cassette 18.

In a function of a dispensing replenishment controlling portion 134, when due to individual replenishment, an individual replenishing instruction including information on the denomination of a coin for replenishment, and the number of coins to be dispensed or dispensing amount is received from the outside of the machine body 12, coins are sent to the corresponding accommodating and dispensing portion 32 from the corresponding replenishment coin input slot 25 through the replenishment chute portion 100, and then the escrow unit 33 is rotated to the second rotation, the pooling and feeding portion 31, transporting unit 29 and accommodating and dispensing portions 32 are driven, coins accommodated in the accommodating and dispensing portions 32 are dispensed one by one and transported by the transporting unit 29, coins recognized as normal coins to be dispensed by the recognition unit 30 are transported to the dispensing tray 17, coins not recognized as normal coins and coins recognized as normal coins but not the coins to be dispensed are transported to the pooling and feeding portion 31, all coins according to a dispensing instruction regarding the denominations and number of coins to be dispensed or dispensing amount are transported to the dispensing tray 17, and then coins are fed one by one from the pooling and feeding portion 31 and transported by the transporting unit 29, a coin recognized as a normal coin by the recognition unit 30 is transported to the coin cassette 18 when the accommodating and dispensing portion 32 for accommodating the corresponding coin is in a full state, or transported to the corresponding accommodating and dispensing portion 32 when the accommodating and dispensing portion is not in the full state, and coins not recognized as normal coins by the recognition unit 30 are transported to the coin cassette 18.

In a function of a collection dispensing controlling portion 136, in the case where the dispensing tray 21 is disposed on the rear face of the machine body 12, the pooling and feeding portion 31, transporting unit 29 and accommodating and dispensing portions 32 are driven, and coins accommodated in the accommodating and dispensing portions 32 are fed one by one and dispensed from the collection coin dispensing port 20 by the transporting unit 29.

In a function of a collection controlling unit 137, when a collecting instruction is received from the outside of the machine body 12, the chute portion 76 of the escrow unit 33 is rotated to the second rotation position, the pooling and feeding portion 31, transporting unit 29 and accommodating and dispensing portions 32 are driven, and coins accommodated in the accommodating and dispensing portions 32 are fed one by one and transported to the coin cassette 18 by the transporting unit 29.

In a function of an outside collection controlling portion 138, when an outside collecting instruction is received from the outside of the machine body 12, the pooling and feeding portion 31, transporting unit 29 and accommodating and dispensing portions 32 are driven, coins accommodated in the accommodating and dispensing portions 32 are fed one by one and transported to the collection coin dispensing port 20 by the transporting unit 29.

Moreover, some of the functions of the controlling portion 111 are sometimes combined and set with each other, or the functions are sometimes separately set in accordance with the first and second specifications.

Next, operation of the coin depositing and dispensing machine 11 will be described.

First, depositing operation in the case of direct deposit will be described with reference to FIG. 14.

Coins to be deposited put in the coin receiving port 14 are collectively received and pooled in the pooling and feeding portion 31.

When a depositing instruction is issued by operation of the deposit starting button 15, the chute portion 76 of the escrow unit 33 is rotated to the second rotation position, the dispensing chute portion 76a of the dispensing escrow unit 34 is rotated to the second dispensing escrow unit position, and the pooling and feeding portion 31 and transporting unit 29 are driven.

Thus, coins in the pooling and feeding portion 31 are fed one by one to the coin passage 38, transported one by one by the belt 46 in the depositing and transporting direction F1, and recognized by the recognition unit 30.

Describing operation of the pooling and feeding portion 31 and transporting unit 29 in detail here, the belt 46 of the transporting unit 29 is driven in the depositing and transporting direction F1, the delivering disc 62 of the pooling and feeding portion 31 is rotated with the belt 46 in the feeding and rotating direction, and the delivering disc 62 of each accommodating and dispensing portion 32 is rotated in the reverse feeding and rotating direction. Then, the rotary disc 60 of the pooling and feeding portion 31 is rotated in the feeding and rotating direction, coins are picked up one by one by the picking-up members 67 of the rotary disc 60 and delivered to the delivering disc 62, the sorting member 50 is here swung to a coin entering/exiting position, and thus the coins are fed one by one to the coin passage 38 by the delivering disc 62. Then, coins fed one by one from the pooling and feeding portion 31 to the coin passage 38 are inserted one by one between the plurality of projections 47 of the rotating belt 46, pushed one by one by the projections 47 at the upstream side in the transporting direction, and transported in the coin passage 38 in the depositing and transporting direction F1.

A coin recognized as a normal coin as a result of recognition by the recognition unit 30 is sorted from the coin passage 38 to the coin inlet/outlet 32a of the accommodating and dispensing portion 32 and accommodated in the accommodating and dispensing portion 32 by the sorting member 50 of the accommodating and dispensing portion 32 for accommodating the coin of the corresponding denomination. The coin is detected by the sensor when being received into the accommodating and dispensing portion 32, and the number of coins accommodated in the accommodating and dispensing portion 32 is managed by the controlling portion 111.

Coins not recognized as normal coins as a result of recognition by the recognition unit 30 are made to pass each accommodating and dispensing portion 32 aside of the coin passage 38, transported to the front end, which is a terminal end, of the second passage portion 44, of the passage 38, ejected to the dispensing escrow unit 34, ejected to the dispensing tray 17 through the dispensing chute portion 76a and returned.

When the number of coins accommodated in the accommodating and dispensing portion 32 reaches a predetermined full number, coins transported thereafter are handled as overflow coins, made to pass each accommodating and dispensing portions 32 aside of the coin passage 38, sorted to the escrow unit 33 by the sorting member 50 of the escrow unit 33, and sent and accommodated into the coin cassette 18 through the chute portion 76 and first chute 87.

When normal coins to be deposited put in the coin receiving port 14 are completely accommodated in the accommodating and dispensing portions 32 or coin cassette 18, a depositing process is ended.

Next, coin escrow operation in the case of a depositing check will be described with reference to FIG. 15.

Coins to be deposited put in the coin receiving port 14 are collectively received and pooled in the pooling and feeding portion 31.

When a depositing instruction is issued by operation of the deposit starting button 15, the chute portion 76 of the escrow unit 33 is rotated to the first rotation position, the dispensing chute portion 76a of the dispensing escrow unit 34 is rotated to the second dispensing escrow unit position, and the pooling and feeding portion 31 and transporting unit 29 are driven.

Thus, coins in the pooling and feeding portion 31 are fed one by one to the coin passage 38, transported one by one by the belt 46 in the depositing and transporting direction F1, and recognized by the recognition unit 30.

Coins recognized as normal coins as a result of recognition by the recognition unit 30 are sorted to the escrow unit 33 by the sorting member 50 at the position of the escrow unit 33, and stored in the chute portion 76 in which the opening 78 is closed by the closing portion 84 of the closing member 83.

Coins not recognized as normal coins as a result of recognition by the recognition unit 30 are transported to the front end, which is the terminal end, of the second passage portion 44, ejected to the dispensing escrow unit 34, ejected to the dispensing tray 17 through the dispensing chute portion 76a and returned.

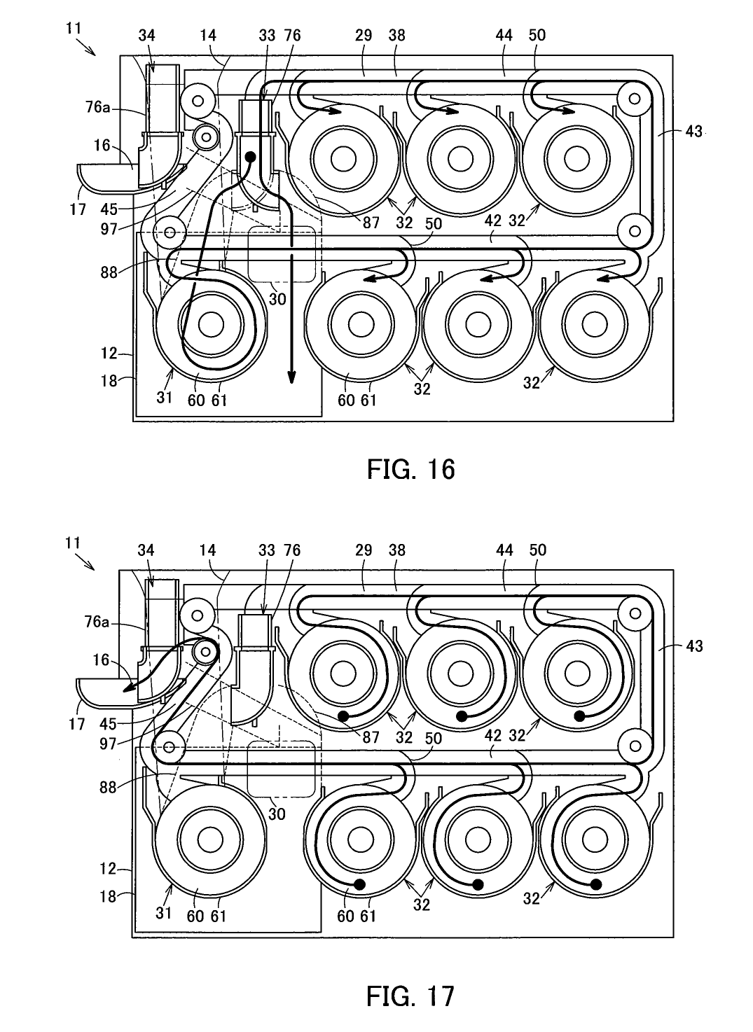

Accommodating operation after coin escrow in the case of the depositing check will be described with reference to FIG. 16.

When an accommodating instruction is issued after escrow of coins to be deposited, the chute portion 76 of the escrow unit 33 is rotated from the first rotation position to the third rotation position, and coins stored in the chute portion 76 of the escrow unit 33 are sent to the pooling and feeding portion 31 through the second chute 88.

Then, the pooling and feeding portion 31 and transporting unit 29 are driven. Thus, coins in the pooling and feeding portion 31 are fed one by one to the coin passage 38, transported one by one by the belt 46 in the depositing and transporting direction F1, and recognized by the recognition unit 30.

A coin recognized as a normal coin as a result of recognition by the recognition unit 30 is sorted from the coin passage 38 to the coin inlet/outlet 32a of the accommodating and dispensing portion 32 and accommodated in the accommodating and dispensing portion 32 by the sorting member 50 of the accommodating and dispensing portion 32 for accommodating the coin of the corresponding denomination. The coin is detected by the sensor when being received into the accommodating and dispensing portion 32, and the number of coins accommodated in the accommodating and dispensing portion 32 is managed by the controlling portion 111.

Coins, which have been recognized as normal coins once but are not recognized as normal coins as a result of recognition by the recognition unit 30, are made to pass each accommodating and dispensing portion 32 aside of the coin passage 38, sorted to the escrow unit 33 by the sorting member 50 of the escrow unit 33, and sent and accommodated into the coin cassette 18 through the chute portion 76 and first chute 87.

When the number of coins accommodated in the accommodating and dispensing portion 32 reaches a predetermined full number, coins of the corresponding denomination transported thereafter are handled as overflow coins, made to pass each accommodating and dispensing portions 32 aside of the coin passage 38, sorted to the escrow unit 33 by the sorting member 50 of the escrow unit 33, and sent and accommodated into the coin cassette 18 through the chute portion 76 and first chute 87.

When temporarily stored coins to be deposited are completely accommodated in the accommodating and dispensing portions 32 or coin cassette 18, a depositing process is ended.

Next, returning operation in the case of the direct deposit will be described with reference to FIG. 17.

When a returning instruction is issued in accordance with a return request from a customer after the direct deposit, the dispensing chute portion 76a of the dispensing escrow unit 34 is rotated to the second dispensing escrow unit position, and the corresponding accommodating and dispensing portions 32 accommodating coins directly deposited and the transporting unit 29 are driven.

Thus, coins in the corresponding accommodating and dispensing portions 32 are fed one by one to the coin passage 38, transported one by one to the front end, which is a terminal end, of the dispensing passage portion 45 by the belt 46 in the dispensing and transporting direction F2, ejected to the dispensing escrow unit 34, and ejected to the dispensing tray 17 through the dispensing chute portion 76a. In the case where coins are dispensed from the plurality of accommodating and dispensing portions 32, coins are dispensed from any one of the accommodating and dispensing portions 32, and then coins to be returned are successively dispensed from the other accommodating and dispensing portions 32. Moreover, since the timings of feeding coins in the accommodating and dispensing portions 32 to the coin passage 38 are adjusted and the corresponding plurality of accommodating and dispensing portions 32 can be simultaneously operated, coins fed to the coin passage 38 can be prevented from interfering with the sorting member 50 of the other accommodating and dispensing portions 32.

Describing operation of the accommodating and dispensing portion 32 and transporting unit 29 in detail here, the belt 46 of the transporting unit 29 is driven in the dispensing and transporting direction F2, the delivering disc 62 of the pooling and feeding portion 31 is rotated with the belt 46 in the reverse feeding and rotating direction, and the delivering disc 62 of each accommodating and dispensing portion 32 is rotated in the feeding and rotating direction. Then, the rotary disc 60 of the corresponding accommodating and dispensing portion 32 is rotated in the feeding and rotating direction, coins are picked up one by one by the picking-up members 67 of the rotary disc 60 and delivered to the delivering disc 62, the sorting member 50 is here swung to the coin entering/exiting position, and thus the coins are fed one by one to the coin passage 38 by the delivering disc 62. Then, coins fed one by one from the accommodating and dispensing portion 32 to the coin passage 38 are inserted one by one between the plurality of projections 47 of the rotating belt 46, pushed one by one by the projections 47 at the upstream side in the transporting direction, and transported in the coin passage 38 in the dispensing and transporting direction F2.

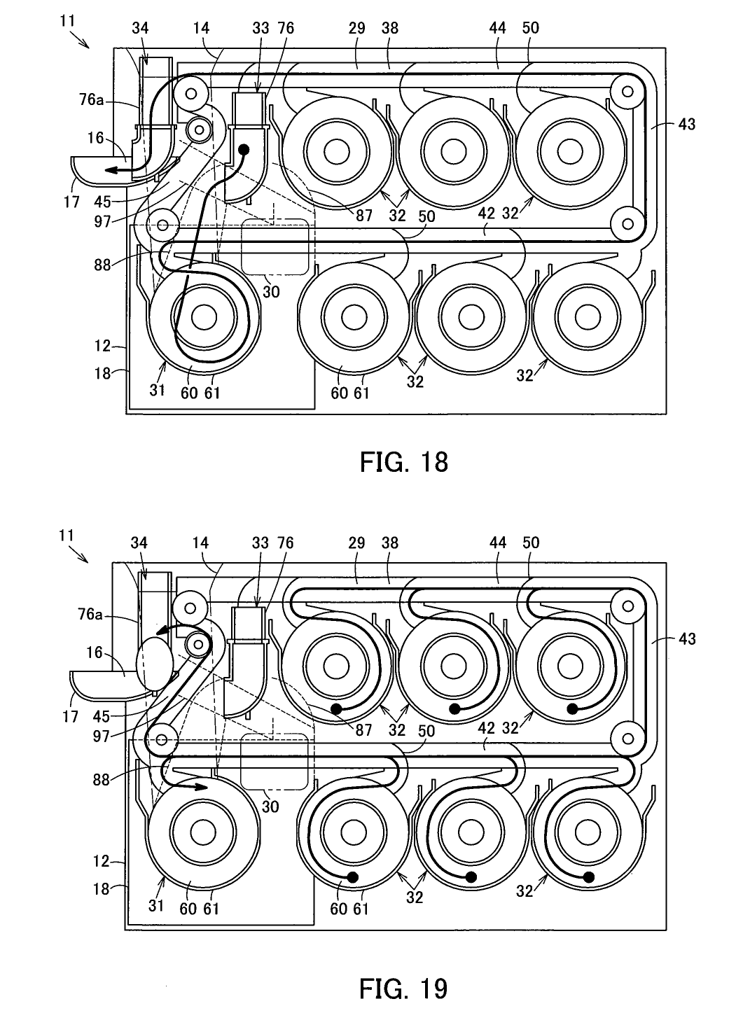

Next, returning operation after coin escrow in the case of the depositing check will be described with reference to FIG. 18.

When a returning instruction is issued in accordance with a return request from a customer after escrow of coins to be deposited, the chute portion 76 of the escrow unit 33 is rotated from the first position to the third rotation position, and coins temporarily stored in the chute portion 76 of the escrow unit 33 are sent to the pooling and feeding portion 31 through the second chute 88.

Then, the dispensing chute portion 76a of the dispensing escrow unit 34 is rotated to the second dispensing escrow unit position, and the pooling and feeding portion 31 and transporting unit 29 are driven. Thus, coins in the pooling and feeding portion 31 are fed one by one to the coin passage 38, transported one by one by the belt 46 in the depositing and transporting direction F1, ejected from the front end, which is the terminal end, of the second passage portion 44 of the coin passage 38 to the dispensing escrow unit 34, ejected to the dispensing tray 17 through the dispensing chute portion 76a and returned.

Next, dispensing operation will be described with reference to FIG. 19.

When a dispensing instruction including the denominations and number of coins to be dispensed or dispensing amount is received, the dispensing chute portion 76a of the dispensing escrow unit 34 is rotated to the first dispensing escrow unit position, and the corresponding accommodating and dispensing portion 32 accommodating coins to be dispensed and the transporting unit 29 are driven.

Thus, coins in the corresponding accommodating and dispensing portion 32 are fed one by one to the coin passage 38, transported one by one by the belt 46 in the dispensing and transporting direction F2, and recognized by the recognition unit 30. In the case where coins are dispensed from the plurality of accommodating and dispensing portions 32, coins are dispensed from any one of the accommodating and dispensing portions 32, and then coins to be dispensed are successively dispensed from the other accommodating and dispensing portions 32. Moreover, since the timings of feeding coins in the accommodating and dispensing portions 32 to the coin passage 38 are adjusted and the corresponding plurality of accommodating and dispensing portions 32 can be simultaneously operated, coins fed to the coin passage 38 can be prevented from interfering with the sorting member 50 of the other accommodating and dispensing portions 32.

Coins recognized as normal coins as a result of recognition by the recognition unit 30 are transported to the front end, which is the terminal end, of the dispensing passage portion 45, ejected to the dispensing escrow unit 34, and stored in the dispensing chute portion 76a in which the opening 78 is closed by the closing portion 84 of the closing member 83.

Coins not recognized as normal coins as a result of recognition by the recognition unit 30 are sorted and accommodated from the coin passage 38 into the pooling and feeding portion 31 by the sorting member 50 of the pooling and feeding portion 31. Since the denomination of a coin not recognized as a normal coin is specified based on the timing of dispensing from the accommodating and dispensing portion 32 and the timing that the coin reaches the recognition unit 30 by transportation of the belt 46, one coin is additionally dispensed from the accommodating and dispensing portion 32 corresponding to the denomination of the coin.

Therefore, coins to be dispensed are stored in the dispensing chute portion 76a.

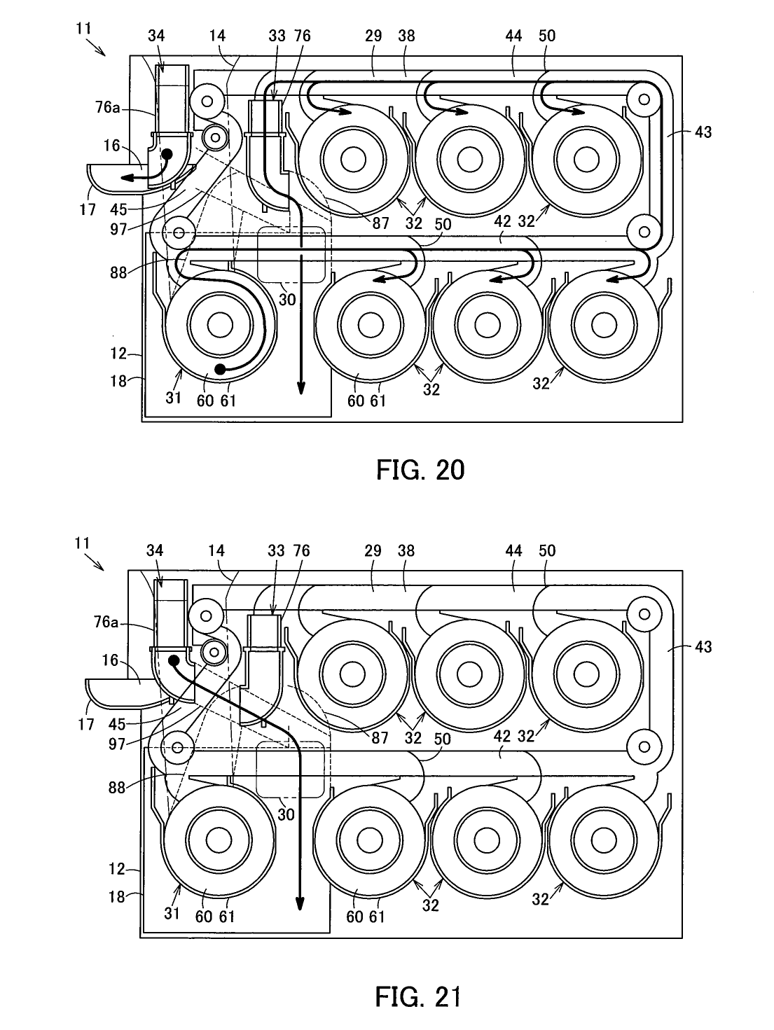

Next, ejecting operation of coins to be dispensed after dispensing escrow and returning operation of coins not recognized as normal coins will be described with reference to FIG. 20.

The dispensing chute portion 76a of the dispensing escrow unit 34 is rotated from the first dispensing escrow unit position to the second dispensing escrow unit position, and coins stored in the dispensing chute portion 76a are ejected to the dispensing tray 17 and dispensed.

The chute portion 76 of the escrow unit 33 is rotated to the second rotation position, and the pooling and feeding portion 31 and transporting unit 29 are driven. Thus, coins not recognized as normal coins and sorted in the pooling and feeding portion 31 are fed one by one to the coin passage 38, transported one by one by the belt 46 in the depositing and transporting direction F1, and recognized by the recognition unit 30.

A coin recognized as a normal coin as a result of recognition by the recognition unit 30 is sorted by the sorting member 50 of the accommodating and dispensing portion 32 for accommodating the coin of the corresponding denomination from the coin passage 38 to the coin inlet/outlet 32a of the accommodating and dispensing portion 32 and accommodated in the accommodating and dispensing portion 32.

Coins not recognized as normal coins as a result of recognition by the recognition unit 30 are made to pass each accommodating and dispensing portion 32 aside of the coin pas sage 38, sorted to the escrow unit 33 by the sorting member 50 of the escrow unit 33, and sent and accommodated into the coin cassette 18 through the chute portion 76 and first chute 87.

Next, coin taking-in operation after dispensing escrow will be described with reference to FIG. 21.

When a taking-in instruction for taking in coins stored in the dispensing chute portion 76a of the dispensing escrow unit 34 due to dispensing stop or the like is issued, the dispensing chute portion 76a of the dispensing escrow unit 34 is rotated from the first dispensing escrow unit position to the third dispensing escrow unit position, and coins stored in the dispensing chute portion 76a are ejected to the third chute 97, and sent and accommodated into the coin cassette 18 through the third chute 97.

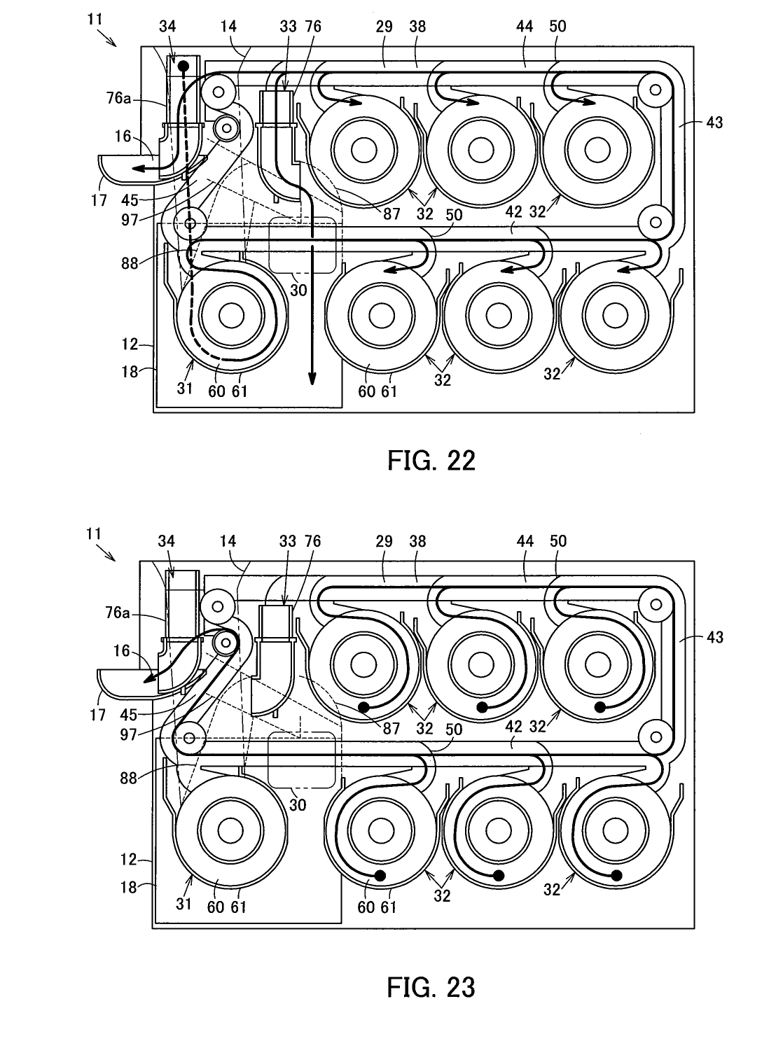

Next, replenishing operation of coins from the coin receiving port 14 will be described with reference to FIG. 22.

In the replenishing operation, coins for replenishment are put into the coin receiving port 14 due to reduction of coins in the machine body 12. The coins for replenishment put in the coin receiving port 14 are received and pooled in the pooling and feeding portion 31.

When a replenishing instruction is received from the outside, the chute portion 76 of the escrow unit 33 is rotated to the second rotation position, the dispensing chute portion 76a of the dispensing escrow unit 34 is rotated to the second dispensing escrow portion position, and the pooling and feeding portion 31 and transporting unit 29 are driven.

Thus, the coins for replenishment in the pooling and feeding portion 31 are fed one by one to the coin passage 38, transported one by one by the belt 46 in the depositing and transporting direction F1, and recognized by the recognition unit 30.

A coin for replenishment recognized as a normal coin as a result of recognition by the recognition unit 30 is sorted by the sorting member 50 of the accommodating and dispensing portion 32 corresponding to the denomination of the coin from the coin passage 38 to the coin inlet/outlet 32a of the accommodating and dispensing portion 32 and accommodated in the accommodating and dispensing portion 32.

Coins not recognized as normal coins as a result of recognition by the recognition unit 30 are made to pass each accommodating and dispensing portion 32 aside of the coin pas sage 38, transported to the front end, which is the terminal end, of the second passage portion 44, ejected to the dispensing escrow unit 34, ejected to the dispensing tray 17 through the dispensing chute portion 76a and returned.

When the number of coins accommodated in the accommodating and dispensing portion 32 reaches a predetermined full number, coins for replenishment of the corresponding denomination transported thereafter are handled as overflow coins, made to pass each accommodating and dispensing portions 32 aside of the coin passage 38, and sorted to the escrow unit 33 by the sorting member 50 of the escrow unit 33. The overflow coins sorted to the escrow unit 33 are sent and accommodated into the coin cassette 18 through the chute portion 76 and first chute 87.

When the normal coins for replenishment put in the coin receiving port 14 are completely accommodated in the accommodating and dispensing portions 32 or coin cassette 18, a replenishing process is ended.

Next, collecting operation, front face collecting operation, of coins to the coin dispensing port 16 will be described with reference to FIG. 23.

When a front face collecting instruction is received from the outside, the dispensing chute portion 76a of the dispensing escrow unit 34 is rotated to the second dispensing escrow unit position, and the accommodating and dispensing portions 32 and transporting unit 29 are driven.

Thus, coins in the accommodating and dispensing portion 32 are fed one by one to the coin passage 38, transported one by one by the belt 46 in the dispensing and transporting direction F2, transported to the front end, which is the terminal end, of the dispensing passage portion 45, ejected to the dispensing escrow unit 34, and ejected to the dispensing tray 17 through the dispensing chute portion 76a.

In the case where coins are dispensed from the plurality of accommodating and dispensing portions 32, coins are dispensed from any one of the accommodating and dispensing portions 32, and then coins are successively dispensed from the other accommodating and dispensing portions 32. Moreover, since the timings of feeding coins in the accommodating and dispensing portions 32 to the coin passage 38 are adjusted and the corresponding plurality of accommodating and dispensing portions 32 can be simultaneously operated, coins fed to the coin passage 38 can be prevented from interfering with the sorting member 50 of the other accommodating and dispensing portion 32.

When a sensor for detecting the dispensing tray 17 is in a full state with coins, which is preset on the dispensing tray 17, detects the full state, the collecting operation is temporarily stopped and coins are prevented from flowing over the dispensing tray 17. Thus, the collecting operation may be restarted by a restarting instruction after taking-out of coins from the dispensing tray 17, or by detecting removal of the full state with use of the sensor.

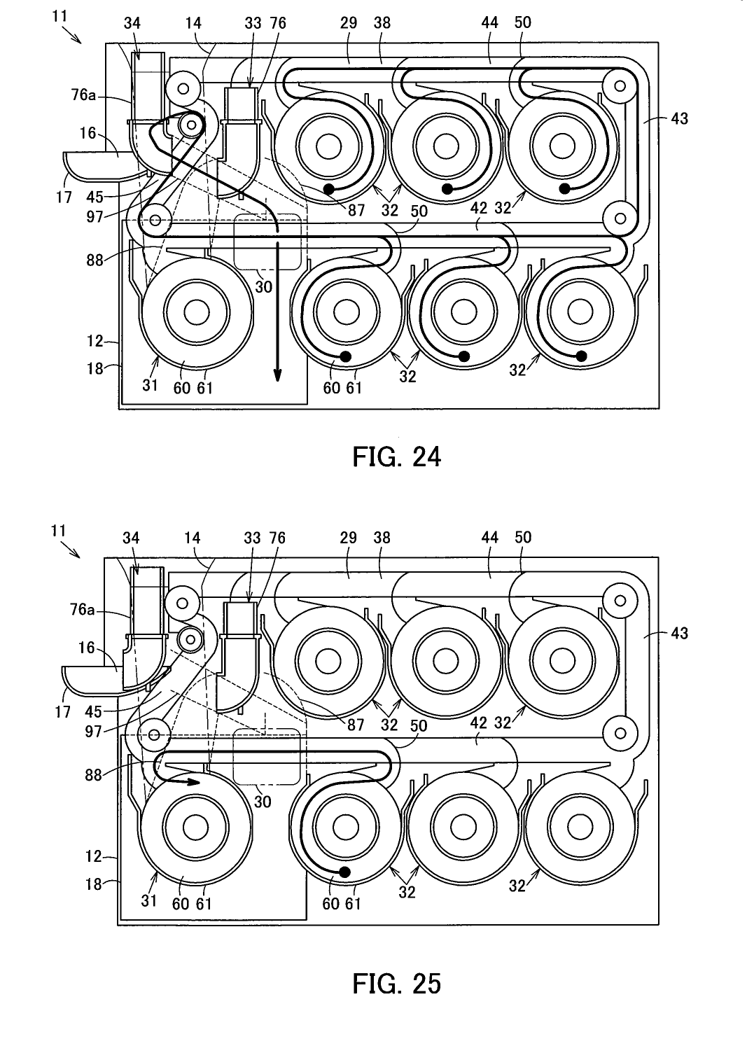

Next, collecting operation of coins to the coin cassette 18 will be described with reference to FIG. 24.

When an inside collecting instruction is received from the outside, the dispensing chute portion 76a of the dispensing escrow unit 34 is rotated to the third dispensing escrow unit position, and the accommodating and dispensing portions 32 and transporting unit 29 are driven.

Thus, coins in the accommodating and dispensing portion 32 are fed one by one to the coin passage 38, transported one by one by the belt 46 in the dispensing and transporting direction F2, transported to the front end, which is the terminal end, of the dispensing passage portion 45, ejected to the dispensing escrow unit 34, and sent and accommodated into the coin cassette 18 through the dispensing chute portion 76a and third chute 97. In the case where coins are dispensed from the plurality of accommodating and dispensing portions 32, coins are dispensed from any one of the accommodating and dispensing portions 32, and then coins are successively dispensed from the other accommodating and dispensing portions 32. Moreover, since the timings of feeding coins in the accommodating and dispensing portions 32 to the coin passage 38 are adjusted and the corresponding plurality of accommodating and dispensing portions 32 can be simultaneously operated, coins fed to the coin passage 38 can be prevented from interfering with the sorting member 50 of the other accommodating and dispensing portions 32.

The coin cassette 18 accommodating all coins accommodated in the machine body 12 is pulled out from the front face of the machine body 12, and the coins are collected.

Next, operation of moving coins in the accommodating and dispensing portion 32 at the time of automatic investigation will be described with reference to FIG. 25.

When an automatically investigating instruction for automatically investigating coins accommodated in each accommodating and dispensing portion 32 is received from the outside, any one of the accommodating and dispensing portions 32 and the transporting unit 29 are driven, coins in the accommodating and dispensing portion 32 are fed one by one to the coin passage 38, transported one by one by the belt 46 in the dispensing and transporting direction F2, recognized by the recognition unit 30, and sorted and accommodated into the pooling and feeding portion 31 by the sorting member 50 of the pooling and feeding portion 31.

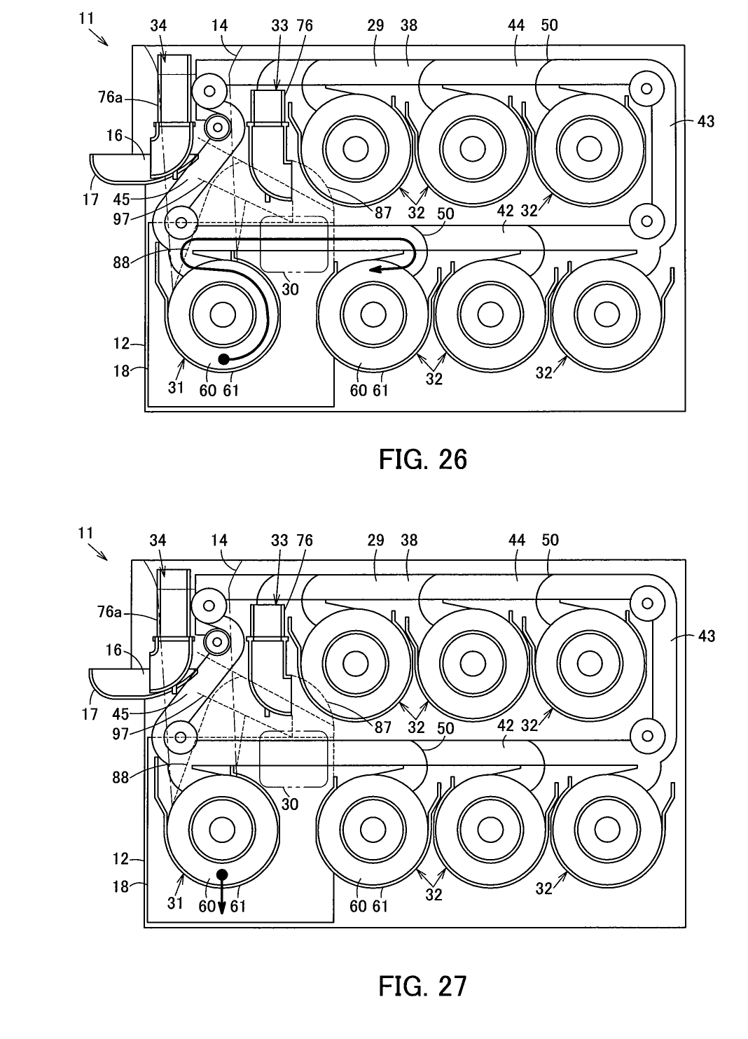

Next, operation of counting coins moved at the time of automatic investigation and returning the coins to the original accommodating and dispensing portion 32 will be described with reference to FIG. 26.

After all coins to be investigated accommodated in the accommodating and dispensing portion 32 are recognized and moved to the pooling and feeding portion 31, the pooling and feeding portion 31 and transporting unit 29 are driven, and coins in the pooling and feeding portion 31 are fed one by one to the coin passage 38, transported one by one by the belt 46 in the depositing and transporting direction F1, recognized by the recognition unit 30, and sorted and accommodated into the accommodating and dispensing portion 32 by the sorting member 50 of the original accommodating and dispensing portion 32.

Coins can be thus recognized by the recognition unit 30 twice in moving coins in the accommodating and dispensing portion 32 to the pooling and feeding portion 31 and in returning the coins to the original accommodating and dispensing portion 32, and can be accurately automatically investigated.

All coins accommodated in the accommodating and dispensing portions 32 in the machine body 12 are investigated in a manner of successively performing such recognition and movement of coins from the accommodating and dispensing portion 32 to the pooling and feeding portion 31 and then recognition and movement of the coins from the pooling and feeding portion 31 to the original accommodating and dispensing portion 32 for all the accommodating and dispensing portions 32.

Next, operation of discharging a foreign object remaining in the pooling and feeding portion 31 will be described with reference to FIG. 27.

A foreign object is sometimes put into the coin receiving port 14 together with coins at the time of depositing or replenishment with coins from the coin receiving port 14. Such a foreign object is not fed from the pooling and feeding portion 31 and remains therein.

Therefore, the foreign object discharge gate of the hopper 61 of the pooling and feeding portion 31 is opened and the foreign object is discharged downward after depositing operation or replenishing operation. The discharged foreign object is received into a foreign object collecting portion, which is arranged removably from the machine body 12, and can be taken out.

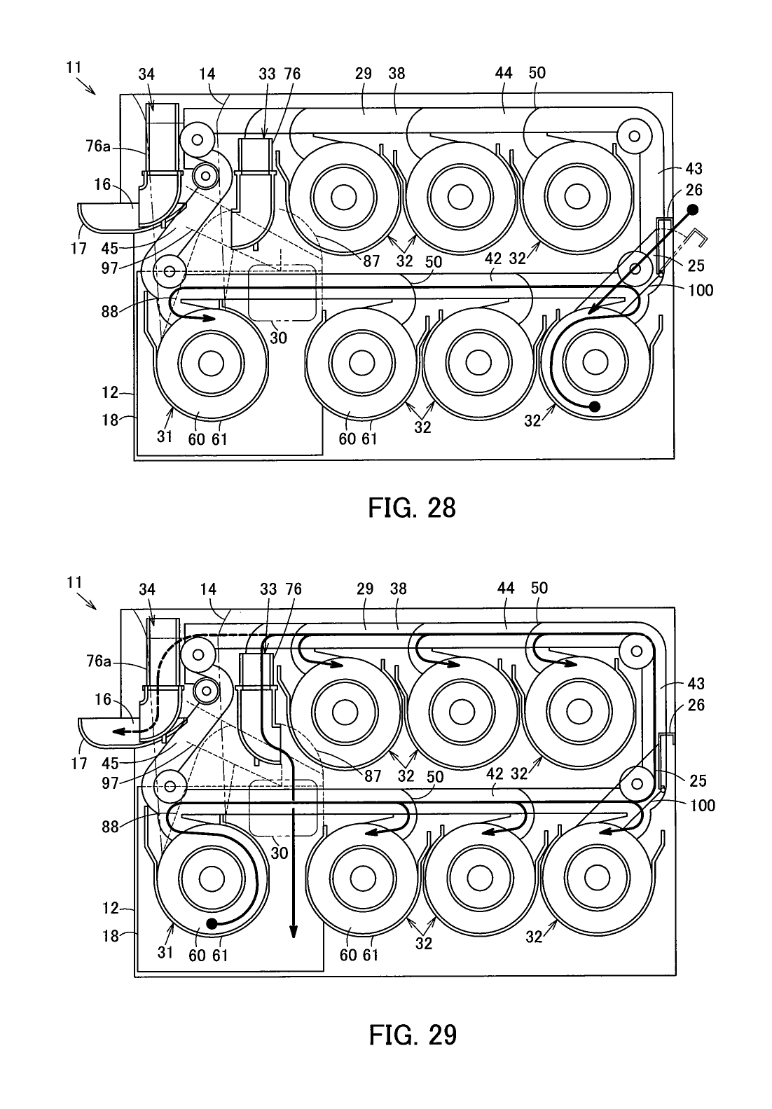

Next, operation until coin escrow at the time of rear face replenishment will be described with reference to FIG. 28.

In the case of the coin depositing and dispensing machine 11, including the individual replenishment function, of the second specification, the accommodating and dispensing portions 32 can be replenished with coins from the rear face of the machine body 12 for each denomination.

When an individual replenishing instruction including information on the denomination of a coin for replenishment is received from the outside, after the replenishment coin input slot door 26 corresponding to the denomination of the coin for replenishment is opened and coins put into the replenishment coin input slot 25 are received into the corresponding accommodating and dispensing portion 32 through the replenishment chute portion 100, close of the replenishment coin input slot door 26 is detected by a preset sensor, and thus the transporting unit 29 and the replenished accommodating and dispensing portion 32 are driven.

Thus, coins in the replenished accommodating and dispensing portion 32 are fed one by one to the coin passage 38, transported one by one by the belt 46 in the dispensing and transporting direction F2, recognized by the recognition unit 30, and sorted and accommodated into the pooling and feeding portion 31 by the sorting member 50 of the pooling and feeding portion 31.

Next, operation of counting coins temporarily stored in the rear face replenishment and performing replenishment will be described with reference to FIG. 29.

After all coins in the replenished accommodating and dispensing portion 32 are recognized and moved to the pooling and feeding portion 31, the chute portion 76 of the escrow unit 33 is rotated to the second rotation position, the dispensing chute portion 76a of the dispensing escrow unit 34 is rotated to the second dispensing escrow unit position, and the pooling and feeding portion 31 and transporting unit 29 are driven.

Thus, the coins for replenishment in the pooling and feeding portion 31 are fed one by one to the coin passage 38, transported one by one by the belt 46 in the depositing and transporting direction F1, and recognized by the recognition unit 30.

A coin recognized as a normal coin as a result of recognition by the recognition unit 30 is sorted by the sorting member 50 of the accommodating and dispensing portion 32 for accommodating the coin of the corresponding denomination from the coin passage 38 to the coin inlet/outlet 32a of the accommodating and dispensing portion 32, and accommodated in the accommodating and dispensing portion 32. Here, since coins for replenishment of the corresponding denomination are individually put into the replenished accommodating and dispensing portion 32, coins fed from the pooling and feeding portion 31 are accommodated in the original accommodating and dispensing portion 32. However, coins of another denomination erroneously put in are accommodated in the accommodating and dispensing portion 32 corresponding to the denomination of the coin.

Coins not recognized as normal coins as a result of recognition by the recognition unit 30 are made to pass each accommodating and dispensing portion 32 aside of the coin pas sage 38, transported to the front end, which is the terminal end, of the second passage portion 44, ejected to the dispensing escrow unit 34, ejected to the dispensing tray 17 through the dispensing chute portion 76a and returned.

When the number of coins accommodated in the accommodating and dispensing portion 32 reaches a predetermined full number, coins for replenishment of the corresponding denomination transported thereafter are handled as overflow coins, made to pass each accommodating and dispensing portions 32 aside of the coin passage 38, sorted to the escrow unit 33 by the sorting member 50 of the escrow unit 33, and sent and accommodated into the coin cassette 18 through the chute portion 76 and first chute 87.

When due to individual replenishment, an individual replenishing instruction including information on the denomination of a coin for replenishment is received from the outside of the machine body 12, coins are sent to the corresponding accommodating and dispensing portion 32 from the corresponding replenishment coin input slot 25 through the replenishment chute portion 100, and then the escrow unit 33 is rotated to the third rotation position, the pooling and feeding portion 31, transporting unit 29 and accommodating and dispensing portions 32 are driven, coins accommodated in the accommodating and dispensing portions 32 are dispensed one by one and transported by the transporting unit 29, coins recognized as normal coins to be dispensed by the recognition unit 30 are transported to the dispensing tray 17, coins not recognized as normal coins and coins recognized as normal coins but not the coins to be dispensed are transported to the pooling and feeding portion 31, all coins according to a dispensing instruction regarding the denominations and number of coins to be dispensed or dispensing amount are transported to the dispensing tray 17, and then coins are fed one by one from the pooling and feeding portion 31 and transported by the transporting unit 29, a coin recognized as a normal coin by the recognition unit 30 is transported to the coin cassette 18 when the accommodating and dispensing portion 32 for accommodating the corresponding coin is in a full state, or transported to the corresponding accommodating and dispensing portion 32 when the accommodating and dispensing portion is not in the full state, and coins not recognized as normal coins by the recognition unit 30 are transported to the coin cassette 18.

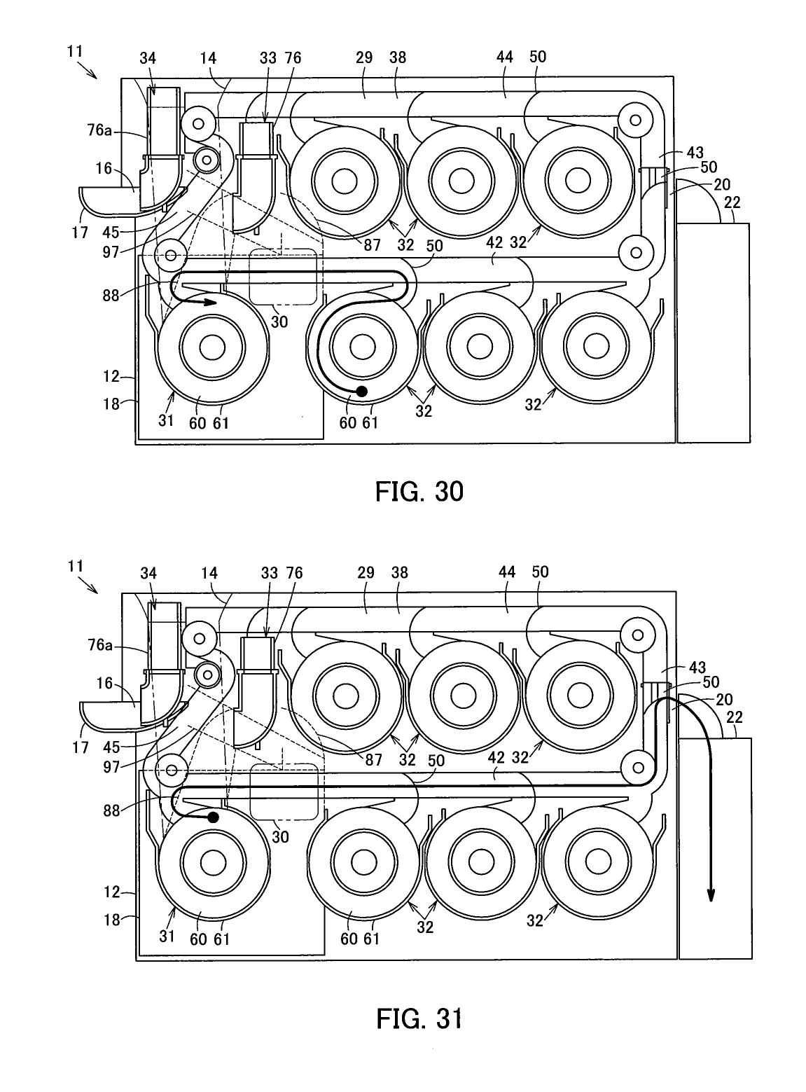

Next, operation of moving coins of the accommodating and dispensing portion 32 at the time of rear face collection will be described with reference to FIG. 30.

In a specification of the coin depositing and dispensing machine 11 in which the machine outside cassette 22 for receiving coins dispensed from the collection coin dispensing port 20 is disposed on the rear face of the machine body 12, when an outside collecting instruction for collecting coins in the machine body 12 into the machine outside cassette 22 is received from the outside, any one of the accommodating and dispensing portions 32 and the transporting unit 29 are driven, and coins in the accommodating and dispensing portion 32 are fed one by one to the coin passage 38, transported one by one by the belt 46 in the dispensing and transporting direction F2, recognized by the recognition unit 30, and sorted and accommodated into the pooling and feeding portion 31 by the sorting member 50 of the pooling and feeding portion 31.

Next, operation of counting coins moved at the time of rear face collection and dispensing the coins from the collection coin dispensing port 20 of the rear face will be described with reference to FIG. 31.

After all coins to be collected accommodated in the accommodating and dispensing portion 32 are recognized and moved to the pooling and feeding portion 31, the pooling and feeding portion 31 and transporting unit 29 are driven, and coins in the pooling and feeding portion 31 are fed one by one to the coin passage 38, transported one by one by the belt 46 in the depositing and transporting direction F1, recognized by the recognition unit 30, sorted to the collection coin dispensing port 20 by the sorting member 50 of the collection coin dispensing port 20, and accommodated into the machine outside cassette 22.

All coins accommodated in the machine body 12 are investigated and collected in a manner of successively performing such recognition and movement of coins from the accommodating and dispensing portion 32 to the pooling and feeding portion 31 and then recognition and movement of the coins from the pooling and feeding portion 31 to the machine outside cassette 22 for all the accommodating and dispensing portions 32.

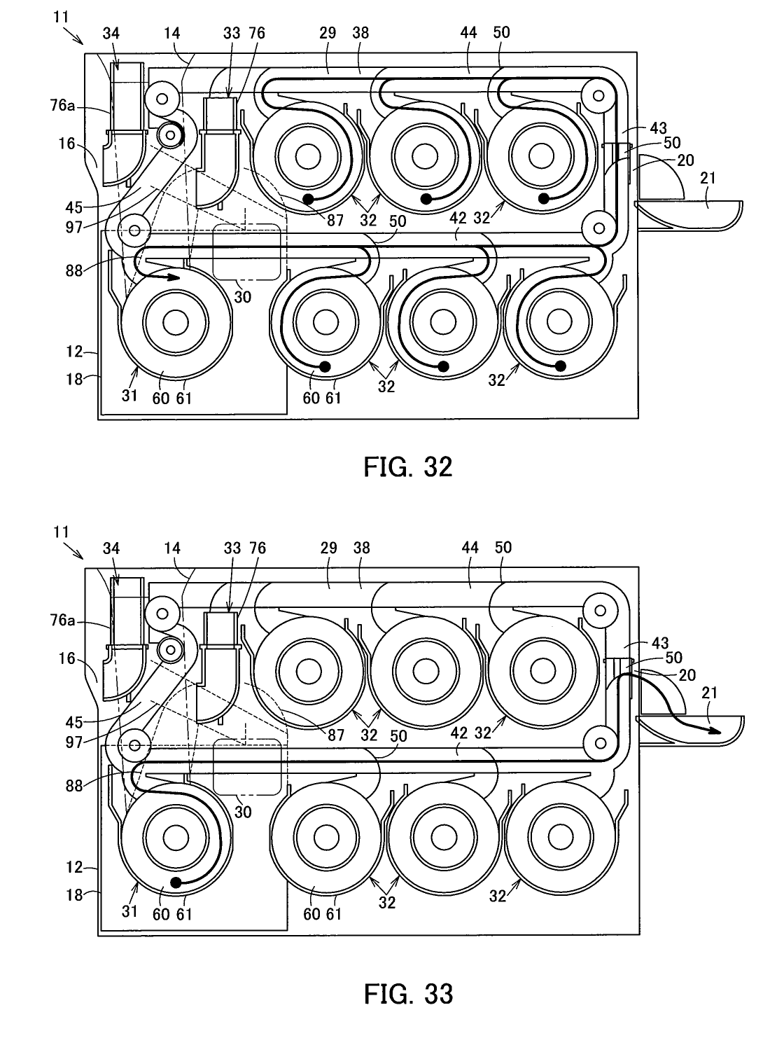

Next, operation of moving coins in the accommodating and dispensing portions 32 at the time of rear face dispensing will be described with reference to FIG. 32.

FIG. 32 shows a specification of the coin depositing and dispensing machine 11 in which the dispensing tray 17 is not disposed on the front face of the machine body 12 and the dispensing tray 21 for receiving coins dispensed from the collection coin dispensing port 20 is disposed on the rear face of the machine body 12, and shows a case of counter management where a cashier and customer face each other. When a dispensing instruction is received from the outside, the corresponding accommodating and dispensing portions 32 accommodating coins to be dispensed and transporting unit 29 are driven.

Moreover, even in the case where the dispensing tray 21 is disposed on the rear face, the dispensing tray 17 may be disposed on the front face. In this case, since the counter management or management by a cashier can be selected, a management form flexible with use situations can be adopted.

Thus, coins in the corresponding accommodating and dispensing portion 32 are fed one by one to the coin passage 38, transported one by one by the belt 46 in the dispensing and transporting direction F2, and recognized by the recognition unit 30. In the case where coins are dispensed from the plurality of accommodating and dispensing portions 32, coins are dispensed from any one of the accommodating and dispensing portions 32, and then coins to be dispensed are successively dispensed from the other accommodating and dispensing portions 32. Moreover, since the timings of feeding coins in the accommodating and dispensing portions 32 to the coin passage 38 are adjusted and the corresponding plurality of accommodating and dispensing portions 32 can be simultaneously operated, coins fed to the coin passage 38 can be prevented from interfering with the sorting member 50 of the other accommodating and dispensing portion 32.

The coins recognized by the recognition unit 30 are sorted and accommodated from the coin passage 38 into the pooling and feeding portion 31 by the sorting member 50 of the pooling and feeding portion 31.

Next, operation of counting coins moved at the time of rear face dispensing and dispensing the coins from the collection coin dispensing port 20 in the rear face will be described with reference to FIG. 33.

After coins to be dispensed are pooled in the pooling and feeding portion 31, the pooling and feeding portion 31 and transporting unit 29 are driven, and coins in the pooling and feeding portion 31 are fed one by one to the coin passage 38, transported one by one by the belt 46 in the depositing and transporting direction F1, recognized by the recognition unit 30, sorted to the collection coin dispensing port 20 by the sorting member 50 of the collection coin dispensing port 20, and ejected to the dispensing tray 21.

In the coin depositing and dispensing machine 11 thus constituted, since the accommodating and dispensing portion 32 can make coins enter/exit the transporting unit 29 and the transporting units 29 of a depositing system and a dispensing system can be made common to each other, a simple mechanism enables the coin dispensing port 16, collection coin dispensing port 20 and replenishment coin input slots 25 to be flexibly arranged in the front face, rear face, and upper or rear face of the machine body 12 respectively. Thus, the counter management can be performed by dispensing coins to be dispensed from the collection coin dispensing port 20 and receiving the coins by the dispensing tray 21, coins to be collected can be collected from the rear face of the machine body 12 by dispensing the coins from the collection coin dispensing port 20, the accommodating and dispensing portion 32 can be directly replenished with coins from the rear face of the machine body 12 through the replenishment chute portion 100 by putting coins for replenishment into the replenishment coin input slot 25, and efficiencies of machine management and fund management can be raised while a cost reduction is realized by the simple constitution.

The escrow unit 33 and dispensing escrow unit 34 are hollow and cylindrical, each including the openings 77, 78 in the upper and lower regions respectively, and have the chute portion 76 and dispensing chute portion 76a respectively, the chute portions 76, the dispensing chute portion 76a each being tilted to the lower region in relation to a vertical direction of the machine body 12 and rotating around a vertical axis passing through an approximate center of the upper opening 77. When the chute portion 76 and dispensing chute portion 76a are located at predetermined rotation positions respectively, the lower openings 78 of the chute portion 76 and dispensing chute portion 76a are closed by the closing members 83 fixed to the machine body 12 and coins can be temporarily stored in the chute portion 76 and dispensing chute portion 76a. When the chute portion 76 and dispensing chute portion 76a are rotated from the predetermined rotation positions to other rotation positions respectively, the coins temporarily stored in the chute portion 76 and dispensing chute portion 76a can be ejected. Therefore, there can be provided multifunctional escrow unit 33 and dispensing escrow unit 34 which have small and simple structures and can serve as transporting chutes capable of continuously transporting coins depending on rotation positions of the chute portion 76 and dispensing chute portion 76a respectively.

The escrow unit 33 is disposed above the coin cassette 18 and pooling and feeding portion 31 so that coins ejected from the escrow unit 33 can be sent to the coin cassette 18 and pooling and feeding portion 31. That is, by controlling switching of the rotation position of the chute portion 76, coins received from the upper face of the chute portion 76 can be stored inside at the first rotation position, coins received from the upper face of the chute portion 76 can be sent to the coin cassette 18 at the second rotation position, and coins received from the upper face of the chute portion 76 can be sent to the pooling and feeding portion 31 at the third rotation position.

A lower face of the dispensing chute portion 76a of the dispensing escrow unit 34 is disposed at least above the dispensing tray 17 disposed on the front face side of the machine body 12 so that coins ejected from the dispensing escrow unit 34 can be sent to the dispensing tray 17.

Since coins are accommodated in the accommodating and dispensing portion 32 with the coins not aligned, there does not arise a conventional case where coins are incorrectly accommodated and standup when being piled up and accommodated in a cylinder. Thus, coins can be reliably accommodated and dispensed. Additionally, basic constitutions of the pooling and feeding portion 31 and accommodating and dispensing portion 32 can be made common to each other.

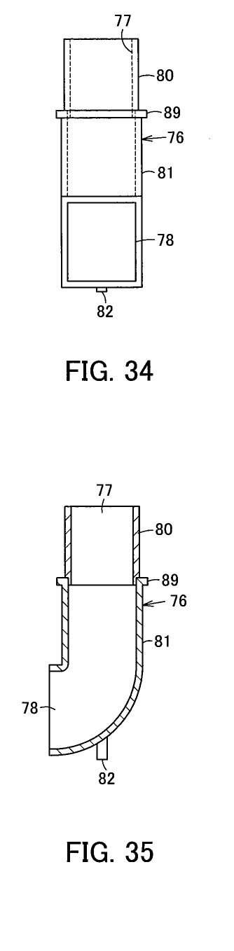

Moreover, as shown in FIGS. 34 and 35, as shapes of the chute portion 76 of the escrow unit 33 and dispensing chute portion 76a of the dispensing escrow unit 34, not only a cylindrical shape but also a four-sided pipe shape and polygonal pipe shape are applicable.

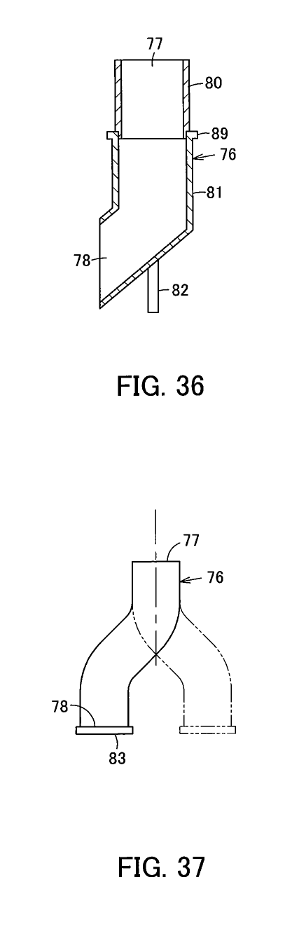

Additionally, as shown in FIG. 36, inner wall faces of the chute portion 76 of the escrow unit 33 and dispensing chute portion 76a of the dispensing escrow unit 34 may be not curved but tilted, the inner wall faces guiding coins received inside to the openings 78 respectively.

Additionally, as shown in FIG. 37, the openings 78 in the lower regions of the chute portion 76 of the escrow unit 33 and dispensing chute portion 76a of the dispensing escrow unit 34 may be opened downward. In this case, if the opening 78 in the lower region is moved vertically eccentrically with the center of the opening 77 in the upper region, the position of the chute portion 76 can be adjusted to a storage position, open position, etc.

The present invention is applied to an automatic change dispenser combined with a POS cash register in, for example, a shop, and to a coin depositing and dispensing machine of an ATM (Automatic Tellers Machine) installed in a teller or inside/outside a bank branch in, for example, a financial institution.

1. A coin depositing and dispensing machine comprising:
a coin receiving port which is disposed in the front of a machine body and receives coins from the outside of the machine body;
a coin dispensing port which is disposed in the front of the machine body and from which coins are dispensed to the outside of the machine body;
a dispensing tray receiving coins dispensed from the coin dispensing port to the outside of the machine body;
a collection coin dispensing port which is disposed at the rear of the machine body and from which coins are dispensed to the outside of the machine body;
a collection coin dispensing port door closing/opening the collection coin dispensing port;
a feeding unit receiving coins put in the coin receiving port and feeding coins one by one;
a transporting unit transporting coins fed by the feeding unit and transporting coins to be dispensed to the coin dispensing port and collection coin dispensing port;
a recognition unit recognizing at least a denomination of a coin transported by the transporting unit;
an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit; and
a coin cassette which is disposed removably from the machine body and capable of collecting coins in the machine body.

2. A coin depositing and dispensing machine comprising:
a coin receiving port which is disposed in the front of a machine body and receives coins from the outside of the machine body;
a coin dispensing port which is disposed in the front of the machine body and from which coins are dispensed to the outside of the machine body;
a collection coin dispensing port which is disposed at the rear of the machine body and from which coins are dispensed to the outside of the machine body;
a collection coin dispensing port door closing/opening the collection coin dispensing port;
a dispensing tray receiving coins dispensed from the collection coin dispensing port to the outside of the machine body;
a feeding unit receiving coins put in the coin receiving port and feeding coins one by one;
a transporting unit transporting coins fed by the feeding unit and transporting coins to be dispensed to the coin dispensing port and collection coin dispensing port;
a recognition unit recognizing at least a denomination of a coin transported by the transporting unit;
an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit;
a coin cassette which is disposed removably from the machine body and capable of collecting coins in the machine body; and
a collection dispensing controlling portion dispensing coins accommodated in the machine body from the collection coin dispensing port.

3. A coin depositing and dispensing machine comprising:
a coin receiving port which is disposed in the front of a machine body and receives coins from the outside of the machine body;
a coin dispensing port which is disposed in the front of the machine body and from which coins are dispensed to the outside of the machine body;
a dispensing tray accepting coins dispensed from the coin dispensing port to the outside of the machine body;
a feeding unit receiving coins put in the coin receiving port and feeding coins one by one;
a transporting unit transporting coins fed by the feeding unit and transporting coins to be dispensed to the coin dispensing port;
a recognition unit recognizing at least a denomination of a coin transported by the transporting unit;
an accommodating and dispensing portion which has a coin inlet/outlet through which coins can enter/exit the transporting unit, receiving coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit;
a coin cassette which is disposed removably from the machine body and capable of collecting coins in the machine body;
a replenishment coin input slot which is disposed at least at an upper side or rear side of the machine body and into which coins for replenishment are put from the outside of the machine body;
a replenishment coin input slot door opening/closing the replenishment coin input slot; and
a replenishment chute portion guiding coins put in from the replenishment coin input slot to the accommodating and dispensing portion.

4. A coin depositing and dispensing machine comprising:
a coin receiving port which is disposed in the front of a machine body and receives coins from the outside of the machine body;
a coin dispensing port which is disposed in the front of the machine body and from which coins are dispensed to the outside of the machine body;
a collection coin dispensing port which is disposed at the rear of the machine body and from which coins are dispensed to the outside of the machine body;
a collection coin dispensing port door closing/opening the collection coin dispensing port;
a feeding unit receiving coins put in the coin receiving port and feeding coins one by one;
a transporting unit transporting coins fed by the feeding unit and transporting coins to be dispensed to the coin dispensing port and collection coin dispensing port;
a recognition unit recognizing at least a denomination of a coin transported by the transporting unit;
an accommodating and dispensing portion which has a coin inlet/outlet through which coins can enter/exit the transporting unit, receives coins, which are put in the coin receiving port from the outside of the machine body, fed from the feeding unit and transported by the transporting unit, one by one through the coin inlet/outlet in accordance with a result of recognition by the recognition unit, accommodates the coins with the coins not aligned, and dispenses accommodated coins one by one through the coin inlet/outlet to the transporting unit;
a coin cassette which is disposed removably from the machine body and capable of collecting coins in the machine body;
a dispensing tray which can receive coins dispensed from the coin dispensing port and collection coin dispensing port respectively, the dispensing tray being removable from the collection coin dispensing port;
a replenishment coin input slot which is disposed at least at an upper side or rear side of the machine body and into which coins for replenishment are put from the outside of the machine body;
a replenishment coin input slot door opening/closing the replenishment coin input slot;
a replenishment chute portion guiding coins put in from the replenishment coin input slot to the accommodating and dispensing portion; and
a collection dispensing controlling portion dispensing coins accommodated in the machine body from the collection coin dispensing port.

5. The coin depositing and dispensing machine according to claim 1, further comprising an escrow unit including:
a chute portion which has a hollow and cylindrical shape having opened upper and lower faces, and a lower part tilted in relation to a vertical direction of the machine body, and can receive coins from the upper face, the coins being transported by the transporting unit;
a rotation-driving unit rotating the chute portion around a vertical axis passing through the center of the upper face of the chute portion; and
a rotation position controlling portion which controls switching of, with use of the rotation-driving unit, a rotation position of the chute portion to a storage position storing coins received inside from the upper face of the chute portion, or to an ejecting position directly ejecting coins from the lower face without storage.

6. The coin depositing and dispensing machine according to claim 5, wherein the escrow unit is disposed above the coin cassette and feeding unit.

7. The coin depositing and dispensing machine according to claim 5, wherein the rotation position controlling unit controls switching of a rotation position of the chute portion to a first rotation position which is a storage position storing coins inside, the coins being received from the upper face of the chute portion, a second rotation position sending coins, which are received from the upper face of the chute portion, to the coin cassette, or a third rotation position sending coins, which are received from the upper face of the chute portion, to the feeding unit.

8. The coin depositing and dispensing machine according to claim 7, further comprising a depositing controlling portion by which, when a depositing instruction is received from the outside of the machine body, the chute portion of the escrow unit is rotated to the first rotation position, the feeding unit and transporting unit are driven, coins received in the coin receiving port are fed one by one by the feeding unit and transported by the transporting unit, coins recognized as normal coins by the recognition unit are transported to the escrow unit, and coins not recognized as normal coins are transported to the dispensing tray.

9. The coin depositing and dispensing machine according to claim 7, further comprising an accommodation controlling portion by which, when an accommodating instruction is received from the outside of the machine body, the chute portion of the escrow unit is rotated to the third rotation position, coins stored in the escrow unit are sent to the feeding unit, the feeding unit and transporting unit are driven, the coins fed to the feeding unit are fed one by one by the feeding unit and transported by the transporting unit, a coin recognized as a normal coin by the recognition unit is transported to the coin cassette when the accommodating and dispensing portion accommodating the corresponding coin is in a full state, or transported to the corresponding accommodating and dispensing portion when the accommodating and dispensing portion is not in the full state, and coins not recognized as normal coins by the recognition unit are transported to the coin cassette.

10. The coin depositing and dispensing machine according to claim 7, further comprising a return controlling portion by which, when a returning instruction is received from the outside of the machine body, the chute portion of the escrow unit is rotated to the third rotation position, coins stored in the escrow unit are sent to the feeding unit, the feeding unit and transporting unit are driven, the coins sent to the feeding unit are fed one by one by the feeding unit and transported by the transporting unit, and all coins stored in the escrow unit are transported to the dispensing tray.

11. The coin depositing and dispensing machine according to claim 1, further comprising a dispensing controlling portion by which, when a dispensing instruction including the denominations and number of coins to be dispensed or dispensing amount is received from the outside of the machine body, the feeding unit, transporting unit and accommodating and dispensing portion are driven, coins accommodated in the accommodating and dispensing portion are dispensed one by one and transported by the transporting unit, coins recognized as normal coins by the recognition unit are transported to the dispensing tray, and coins not recognized as normal coins are transported to the feeding unit.

12. The coin depositing and dispensing machine according to claim 7, further comprising a dispensing reject controlling portion by which, when a dispensing instruction including the denominations and number of coins to be dispensed or dispensing amount is received from the outside of the machine body, the chute portion of the escrow unit is rotated to the second rotation position, the feeding unit, transporting unit and accommodating and dispensing portion are driven, coins accommodated in the accommodating and dispensing portion are dispensed one by one and transported by the transporting unit, coins recognized as normal coins by the recognition unit are transported to the dispensing tray, coins not recognized as normal coins are transported to the feeding unit, and re-fed one by one from the feeding unit and transported by the transporting unit after coins according to the dispensing instruction regarding the denominations and number of coins to be dispensed or dispensing amount are transported to the dispensing tray, coins recognized as normal coins by the recognition unit are transported to the corresponding accommodating and dispensing portion, and coins not recognized as normal coins are transported to the coin cassette.

13. The coin depositing and dispensing machine according to claim 1, further comprising a dispensing escrow unit including:
a dispensing chute portion which has a hollow and cylindrical shape having opened upper and lower faces, and a lower part tilted in relation to a vertical direction of the machine body, and can receive coins from the upper face, the coins being transported by the transporting unit;
a dispensing chute portion rotation-driving unit rotating the dispensing chute portion around a vertical axis passing through the center of the upper face of the dispensing chute portion; and
a dispensing chute portion rotation position controlling portion which controls switching of, with use of the dispensing chute portion rotation-driving unit, a rotation position of the dispensing chute portion to a storage position storing coins received inside from the upper face of the dispensing chute portion or to an ejecting position directly ejecting coins from the lower face without storage.

14. The coin depositing and dispensing machine according to claim 13, wherein the lower face of the dispensing chute portion of the dispensing escrow unit is disposed at least above the dispensing tray disposed on a front face side of the machine body.

15. The coin depositing and dispensing machine according to claim 13, wherein the dispensing chute portion rotation position controlling unit switches a rotation position of the dispensing chute portion to a first dispensing escrow unit position storing coins inside, which are received from the upper face of the dispensing chute portion, a second dispensing escrow unit position sending coins, which are received from the upper face of the dispensing chute portion, to the dispensing tray, or a third dispensing escrow unit position sending coins, which are received from the upper face of the dispensing chute portion, to the coin cassette.

16. The coin depositing and dispensing machine according to claim 15, further comprising a dispensing escrow controlling portion by which, when a dispensing instruction including the denominations and number of coins to be dispensed or dispensing amount is received from the outside of the machine body, the dispensing chute portion of the dispensing escrow unit is rotated to the first dispensing escrow unit position, the feeding unit, transporting unit and accommodating and dispensing portion are driven, coins accommodated in the accommodating and dispensing portion are fed one by one and transported by the transporting unit, coins recognized as normal coins by the recognition unit are transported to the dispensing escrow unit, and coins not recognized as normal coins are transported to the feeding unit.

17. The coin depositing and dispensing machine according to claim 15, further comprising a dispensing escrow reject controlling portion by which, when a dispensing instruction including the denominations and number of coins to be dispensed or dispensing amount is received from the outside of the machine body, the dispensing chute portion of the dispensing escrow unit is rotated to the first dispensing escrow unit position, the feeding unit, transporting unit and accommodating and dispensing portion are driven, coins accommodated in the accommodating and dispensing portion are fed one by one and transported by the transporting unit, coins recognized as normal coins by the recognition unit are transported to the dispensing escrow unit, coins not recognized as normal coins are transported to the feeding unit, all coins according to the dispensing instruction regarding the denominations and number of coins to be dispensed or dispensing amount are transported to the dispensing escrow unit, and then the dispensing chute portion of the dispensing escrow unit is rotated to the second dispensing escrow unit position, coins to be dispensed in the dispensing escrow unit are sent to the dispensing tray, and the coins not recognized as normal coins are re-fed one by one from the feeding unit and transported by the transporting unit, coins recognized as normal coins by the recognition unit are transported to the corresponding accommodating and dispensing portion, and coins not recognized as normal coins are transported to the coin cassette.

18. The coin depositing and dispensing machine according to claim 7, further comprising a replenishment controlling portion by which, when a replenishing instruction is received from the outside of the machine body, the chute portion of the escrow unit is rotated to the second rotation position, the feeding unit and transporting unit are driven, coins for replenishment received from the coin receiving port are fed one by one by the feeding unit and transported by the transporting unit, a coin for replenishment recognized as a normal coin by the recognition unit is transported to the coin cassette when the accommodating and dispensing portion accommodating the corresponding coin is in a full state, or transported to the corresponding accommodating and dispensing portion when the accommodating and dispensing portion is not in the full state, and coins for replenishment not recognized as normal coins by the recognition unit are transported to the dispensing tray.

19. The coin depositing and dispensing machine according to claim 3, further comprising an individual replenishment controlling portion by which, when an individual replenishing instruction including information on the denomination of a coin for replenishment is received from the outside of the machine body, after the corresponding replenishment coin input slot door is opened and coins put in the replenishment coin input slot are received in the corresponding accommodating and dispensing portion, close of the replenishment coin input slot door is detected, and thus the transporting unit and accommodating and dispensing portion are driven, coins are fed one by one from the accommodating and dispensing portion and transported to the feeding unit by the transporting unit, the accommodating and dispensing portion is stopped after all coins in the accommodating and dispensing portion are fed, the feeding unit and transporting unit are driven, coins are fed one by one from the feeding unit and transported by the transporting unit, coins recognized as normal coins by the recognition unit are transported to the coin cassette when the accommodating and dispensing portion accommodating the corresponding coin is in a full state, or to the corresponding accommodating and dispensing portion when the accommodating and dispensing portion is not in the full state, and coins not recognized as normal coins by the recognition unit are transported to the coin cassette.

20. The coin depositing and dispensing machine according to claim 3, further comprising an individual replenishment controlling portion by which, when an individual replenishing instruction including information on the denomination of a coin for replenishment is received from the outside of the machine body, the corresponding replenishment coin input slot door is opened, and coins are received into the replenishment coin input slot from the outside of the machine body and sent to the corresponding accommodating and dispensing portion through the replenishment chute portion.

21. The coin depositing and dispensing machine according to claim 20, further comprising a dispensing replenishment controlling portion by which, when a dispensing instruction including the denominations and number of coins to be dispensed or dispensing amount is received from the outside of the machine body, the feeding unit, transporting unit and accommodating and dispensing portion are driven, coins accommodated in the accommodating and dispensing portion are dispensed one by one and transported by the transporting unit, coins recognized as normal coins to be dispensed by the recognition unit are transported to the dispensing tray, coins not recognized as normal coins and coins recognized as normal coins but not the coins to be dispensed are transported to the feeding unit, all coins according to the dispensing instruction regarding the denominations and number of coins to be dispensed or dispensing amount are transported to the dispensing tray, and then coins are fed one by one from the feeding unit and transported by the transporting unit, a coin recognized as a normal coin by the recognition unit is transported to the coin cassette when the accommodating and dispensing portion accommodating the corresponding coin is in a full state, or transported to the corresponding accommodating and dispensing portion when the accommodating and dispensing portion is not in the full state, and coins not recognized as normal coins by the recognition unit are transported to the coin cassette.

22. The coin depositing and dispensing machine according to claim 7, further comprising a collection controlling portion by which, when a collecting instruction is received from the outside of the machine body, the chute portion of the escrow unit is rotated to the second rotation position, the feeding unit, transporting unit and accommodating and dispensing portion are driven, and coins accommodated in the accommodating and dispensing portion are fed one by one and transported to the coin cassette by the transporting unit.

23. The coin depositing and dispensing machine according to claim 1, further comprising an outside collection controlling portion by which, when an outside collecting instruction is received from the outside of the machine body, the feeding unit, transporting unit and accommodating and dispensing portion are driven, and coins accommodated in the accommodating and dispensing portion are fed one by one and transported to the collection coin dispensing port by the transporting unit.

24. The coin depositing and dispensing machine according to claim 1, further comprising sorting members sorting coins transported by the transporting unit to the accommodating and dispensing portion in accordance with a result of recognition by the recognition unit.

25. The coin depositing and dispensing machine according to claim 1, wherein the transporting unit has a circular coin passage and an endless transporting body having a plurality of projections for pushing and transporting coins in the coin passage one by one and capable of moving along the coin passage.

26. The coin depositing and dispensing machine according to claim 1, wherein the feeding unit and accommodating and dispensing portion each includes a rotary disc which is rotated, around a rotary axis attached to the machine body, at a position tilted at a predetermined angle in relation to a horizontal direction, and a hopper accommodating coins, which are received on a surface side of the rotary disc, with the coins not aligned.
